(19) United States
(12) Patent Application Publication
(10) Pub. No.: US 2025/0153506 A1
(43) Pub. Date: May 15, 2025

(54) WHEEL HUB ASSEMBLY

(71) Applicant: HAYES BICYCLE GROUP INC., Mequon, WI (US)

(72) Inventor: Shawn T COTTER, Grafton, WI (US)

(73) Assignee: HAYES BICYCLE GROUP INC., MEQUON, WI (US)

(21) Appl. No.: 18/943,716

(22) Filed: Nov. 11, 2024

Related U.S. Application Data
(60) Provisional application No. 63/548,381, filed on Nov. 13, 2023.

(51) Int. Cl. B60B 27/02; B60B 27/04; F16D 41/30

(52) U.S. Cl. CPC B60B 27/023; B60B 27/047; F16D 41/30

(57) ABSTRACT

A wheel hub assembly for a bicycle is disclosed. The assembly may comprise a hub shell and a hub body configured for an axle/wheel and a ratchet mechanism comprising a ratchet ring and a pawl system and a magnet arrangement. The magnet arrangement may be configured to magnetically couple the ratchet mechanism of the hub body to the hub shell and the pawl system to the ratchet ring. The ratchet mechanism may be retained in the hub shell; the pawl system may couple the ratchet ring to the hub body in an engaged state. The magnet arrangement may comprise a set of magnets within a set of pockets within the hub shell; a magnet ring may be configured to clip onto the ratchet ring. The ratchet ring may comprise a magnetizable material; the magnet arrangement may magnetize the magnetizable material of the ratchet ring; a set of pawls may comprise a magnetizable material. The hub body may be engaged for rotation with the hub shell in the engaged state and disengaged for rotation independent of the hub shell in a disengaged state.

### CROSS-REFERENCE TO RELATED APPLICATIONS

The present application claims priority to U.S. Provisional Patent Application No. 63/548,381 titled “WHEEL HUB ASSEMBLY” filed Nov. 13, 2023.

The present application is related to and incorporates by reference in full the following patent applications: (a) U.S. Provisional Patent Application No. 63/548,381 titled “WHEEL HUB ASSEMBLY” filed Nov. 13, 2023; (b): U.S. patent application Ser. No. 16/449,439 titled “WHEEL HUB ASSEMBLY” filed Jun. 23, 2019, now U.S. Pat. No. 11,090,977, granted Aug. 18, 2021.

### FIELD

The present invention relates to a wheel hub assembly for a bicycle.

### BACKGROUND

It is known to provide a wheel hub assembly for a bicycle to engage and couple the rear wheel to a drive system (such as pedals configured to transmit power) in a forward direction (e.g. for forward motion) and to disengage and decouple the drive system and the wheel and to allow free rotary motion/rotation relative to the wheel other than in the forward direction (e.g. gliding, coasting or “free-wheeling” or etc.). In typical use the operator/rider of such a bicycle may not infrequently transition the rear wheel/wheel hub assembly between the engaged state (e.g. while pedaling/applying power) and the disengaged/free-wheel state (e.g. while coasting, slowing, braking/stopped, shifting, etc.).

It would be advantageous to provide an improved wheel hub assembly that is configured to transition quickly and efficiently between the disengaged state and engaged state, including responsively and rapidly when intended.

It would be advantageous to provide an improved wheel hub assembly that is configured to facilitate improved performance including enhanced responsiveness in transitions between engagement and disengagement and/or improved durability in application/use, including for road biking, mountain biking, electronic bikes (e.g. with motor-driven drive systems), etc.

It would be advantageous to provide an improved configuration for a wheel hub assembly that employs a magnet arrangement for coupling of elements within the wheel hub assembly to provide for improved performance in application/use.

It would be advantageous to provide an improved configuration for a wheel hub assembly that can be produced in a compact structure/form and that by design provides the capability for improved performance in application/use.

It would be advantageous to provide an improved configuration for a wheel hub assembly that can be produced in a compact structure/form and that by design provides the capability for improved performance in application/use such as reduced internal resistance within the wheel hub assembly.

### SUMMARY

The present invention relates to a hub assembly for a wheel with an axle comprising a hub shell configured to be coupled to the wheel and a hub body configured to be coupled to the axle and a ratchet mechanism comprising a ratchet ring and a pawl system configured to engage the hub body with the hub shell; the ratchet mechanism may be configured to provide an engaged state where the hub body may be configured to rotate together with the hub shell; the ratchet mechanism may be configured to provide a disengaged state where the hub body may be configured to rotate independently relative to the hub shell; the ratchet mechanism may be configured to magnetically couple the pawl system with the ratchet ring. The ratchet mechanism may comprise a set of pawls for engagement with gear teeth within the ratchet mechanism. A magnet arrangement may be configured to provide magnetic engagement; the magnet arrangement may comprise the set of magnets within the hub shell. The magnet arrangement may be configured to provide for magnetization of the ratchet ring of the ratchet mechanism; wherein the ratchet ring of the ratchet mechanism may be configured to magnetically engage a set of pawls to provide the engaged state for the ratchet mechanism. Each magnet within the set of magnets may comprise a disc magnet. The magnet arrangement may comprise a set of magnets adjacent to the ratchet ring to magnetize the ratchet ring to provide magnetic attraction of the set of pawls of the pawl system into the ratchet ring.

The present invention relates to a hub assembly for a wheel comprising an axle comprising a hub shell and a hub body configured for the axle of the wheel and a ratchet mechanism comprising a ratchet ring and a pawl system and a magnet arrangement comprising a set of magnets configured to magnetically couple the pawl system to the ratchet ring; the ratchet mechanism may be configured to be retained in the hub shell; the pawl system may be configured to couple the ratchet ring to the hub body in an engaged state. The hub body may be configured to be engaged for rotation with the hub shell in the engaged state and the hub body may be configured to be disengaged for rotation independent of the hub shell in a disengaged state. The pawl system may be configured to be magnetically drawn into engagement with the ratchet ring; the pawl system may comprise a set of pawls configured to couple the ratchet ring to the hub body by engagement with a set of teeth on the ratchet ring.

The present invention relates to hub assembly for a wheel comprising an axle comprising a hub shell configured to be coupled to the wheel and a hub body configured for the axle of the wheel and a ratchet mechanism comprising a ratchet ring and a pawl system and a magnet arrangement configured to provide for magnetically coupling for the ratchet mechanism of the hub body to the hub shell; the magnet arrangement may be configured to magnetically couple the pawl system to the ratchet ring; the ratchet mechanism may be configured to be retained in the hub shell; the pawl system may be configured to couple the ratchet ring to the hub body in an engaged state. The magnet arrangement may comprise a set of magnets within a set of pockets within the hub shell; the magnet arrangement may comprise a magnet ring; the magnet ring may be configured to clip onto the ratchet ring. The magnet ring may comprise a clip ring configured to clip into a slot of the ratchet ring; the magnet ring may be configured to fit adjacent to the ratchet ring; the magnet arrangement may comprise a magnet ring within a recess within the hub shell; the recess may comprise a groove; the magnet ring may be configured to project from the groove adjacent to the ratchet ring. The ratchet ring may comprise a magnetizable material; the magnet arrangement may be configured to magnetize the magnetizable material of the ratchet ring; the pawl system may comprise a set of pawls; the set of pawls may comprise a magnetizable material. The hub body may be configured to be engaged for rotation with the hub shell in the engaged state and the hub body may be configured to be disengaged for rotation independent of the hub shell in a disengaged state.

The present invention relates to an improved wheel hub assembly for a bicycle.

The present invention relates to an improved wheel hub assembly that is configured to transition quickly and efficiently between the disengaged state and engaged state, including responsively and rapidly when intended.

The present invention relates to an improved wheel hub assembly that is configured to facilitate improved performance including enhanced responsiveness in transitions between engagement and disengagement and/or improved durability in application/use, including for road biking, mountain biking, electronic bikes (e.g. with motor-driven drive systems), etc.

The present invention relates to an improved configuration for a wheel hub assembly that can be produced in a compact structure/form and that by design provides the capability for improved performance in application/use such as reduced internal resistance within the wheel hub assembly.

The present invention relates to a hub assembly for a wheel with an axle. The hub assembly for a wheel with an axle may comprise a hub shell configured to be coupled to the wheel and a hub body configured to be coupled to the axle and a ratchet mechanism comprising a ratchet ring configured to couple the hub body to the hub shell; the ratchet mechanism may be configured to provide an engaged state where the hub body is configured to rotate together with the hub shell; the ratchet mechanism may be configured to provide a disengaged state where the hub body is configured to rotate independently relative to the hub shell; the ratchet mechanism is configured for magnetic engagement with the hub body. The engaged state may comprise a power-transmission state configured for transmission of power to the wheel and the disengaged state may comprise a free-wheel state. The engaged state may comprise a power-transmission state configured for transmission of power to the wheel from the hub body to the hub shell and the disengaged state may comprise a free-wheel state. The ratchet ring of the ratchet mechanism may be configured to engage a set of pawls to provide the engaged state for the ratchet mechanism. The ratchet ring of the ratchet mechanism may be configured to engage a set of pawls with the hub body to provide the engaged state for the ratchet mechanism. The ratchet ring of the ratchet mechanism may be configured for magnetic engagement with the set of pawls. The set of pawls may be pivotally coupled to the hub body. The set of pawls is configured for magnetic engagement with the ratchet ring of the ratchet mechanism. The assembly may comprise a magnet arrangement configured to provide for magnet engagement. The magnet arrangement may comprise a set of magnets. The magnet arrangement may comprise the set of magnets within the hub shell. The magnet arrangement may comprise the set of magnets within a set of seats within the hub shell. The magnet arrangement may be configured to provide for magnetization of the ratchet ring of the ratchet mechanism; the ratchet ring of the ratchet mechanism may be configured to magnetically engage a set of pawls to provide the engaged state for the ratchet mechanism. Magnetic engagement with the ratchet ring of the ratchet mechanism may comprise magnetic attraction of a set of pawls to the ratchet ring. Magnetic engagement with the ratchet ring of the ratchet mechanism may comprise magnetic attraction of the set of pawls into a set of teeth of the ratchet ring. Magnetic engagement with the ratchet ring of the ratchet mechanism may comprise magnetic attraction of the set of pawls into the set of teeth of the ratchet ring by magnetization from a magnet arrangement. Magnetic engagement with the ratchet ring of the ratchet mechanism may comprise magnetic attraction of the set of pawls into the set of teeth of the ratchet ring by magnetization from a set of magnets of the magnet arrangement. The ratchet ring may be magnetized. The ratchet ring may comprise a magnetizable material. The set of pawls may comprise a magnetizable material and/or metallic material. The ratchet ring may comprise a metallic material. The ratchet ring may comprise a set of teeth. The ratchet mechanism may comprise a set of pawls coupled to the hub body and configured to engage the set of teeth of the ratchet ring. The ratchet ring may comprise a set of teeth configured to engage the set of pawls. In the engaged state of the ratchet mechanism the set of pawls is in engagement with the set of teeth. In the engaged state of the ratchet mechanism the set of pawls is magnetically drawn into engagement with the set of teeth. The assembly may comprise a magnet arrangement configured to provide for magnetic engagement of the ratchet mechanism with the hub body. The ratchet ring of the ratchet mechanism may be configured to engage a set of pawls to provide the engaged state for the ratchet mechanism. The hub body may be configured to be mechanically coupled to the hub shell through the ratchet mechanism. The hub body may be configured to be magnetically coupled for engagement with the hub shell. The hub body may be configured to be magnetically coupled at the ratchet mechanism for engagement with the hub shell. The hub body may be configured to be magnetically coupled at the ratchet ring of the ratchet mechanism for engagement with the hub shell. The ratchet mechanism may be configured to provide the engaged state where the hub body with the axle is configured to rotate together with the hub shell with the wheel. The ratchet mechanism may be configured to provide the disengaged state where the hub body with the axle is configured to rotate independently relative to the hub shell with the wheel. The ratchet mechanism may comprise a springless mechanism. The hub shell may be coupled to the hub body by magnetic engagement at the ratchet mechanism. The assembly may comprise a magnet arrangement configured to magnetically couple the hub body to the hub shell. The magnet arrangement may comprise a set of magnets. The hub shell may comprise a set of recesses for the set of magnets. The magnet arrangement may be configured to magnetize the ratchet ring. The ratchet ring may comprise a set of lobes. The hub shell may comprise a set of indentations; the set of indentations of the hub shell may be configured to engage the set of lobes of the ratchet ring. The ratchet ring may comprise a set of interface surfaces; each magnet in the set of magnets may be configured magnetize the ratchet ring at each interface surface of the ratchet ring. The set of interface surfaces of the ratchet ring is positioned between the set of lobes of the ratchet ring. Each of a set of interface surfaces of the ratchet ring may be positioned between each of a set of lobes of the ratchet ring. The ratchet ring may be configured to be installed in the hub body in an aligned condition or an offset condition. The free-wheel state may comprise disengagement of the hub body from the hub shell and disengagement of transmission of power from the axle from the wheel. The ratchet mechanism may comprise a springless configuration; magnetic engagement of the ratchet ring may be configured to provide for reduced hub drag effect. Each magnet within the set of magnets may comprise a disc magnet. Each magnet within the set of magnets may comprise a bar magnet. The hub body may comprise a free hub body.

The present invention relates to a hub assembly for a wheel. The hub assembly may comprise a hub shell coupled to the wheel and a hub body configured for an axle and a ratchet mechanism comprising a ratchet ring and a pawl system and a magnet arrangement configured to provide for magnetically coupling at the ratchet mechanism of the hub body to the hub shell; the magnet arrangement may comprise a set of magnets configured to magnetically couple the pawl system to the ratchet ring; the ratchet mechanism may be configured to be retained in the hub shell; the pawl system may be configured to couple the ratchet ring to the hub body in an engaged state. The pawl system may comprise a set of pawls. The magnet arrangement may comprise magnetization of the ratchet ring. The magnet arrangement may comprise the set of magnets within the hub shell. The magnet arrangement may comprise the set of magnets within a set of pockets in the hub shell. The hub body may be configured to be engaged for rotation with the hub shell in the engaged state. The hub body may be configured to be disengaged for rotation independent of the hub shell in a disengaged state. The hub body may be configured to be engaged for rotation with the hub shell in the engaged state with the pawl system magnetically attracted into engagement with the ratchet ring. The hub body may be configured to be engaged for rotation with the hub shell in the engaged state; the pawl system is magnetically drawn into mechanical engagement with the ratchet ring. The ratchet mechanism may be configured to be magnetically drawn into engagement of the hub body and the hub shell. The hub body may be configured to be magnetically coupled at the ratchet ring of the ratchet mechanism for engagement with the hub shell. The hub body may be configured to be engaged for rotation with the hub shell in the engaged state; the pawl system is magnetically drawn into engagement with the ratchet ring. The hub body may be configured to be magnetically coupled by the pawl system at the ratchet ring of the ratchet mechanism for engagement with the hub shell. The pawl system may comprise a set of pawls configured to couple the ratchet ring to the hub body by engagement with a set of teeth on the ratchet ring. The ratchet ring mechanism may be configured to be retained in the hub shell by a locking ring. The pawl system may comprise a set of pawls pivotally coupled to the hub body. Rotation of the hub shell may comprise (a) rotation with engagement with the hub body when the pawl system is engaged with the ratchet ring and (b) rotation without engagement with the hub body when the pawl system is disengaged from the ratchet ring. The magnet arrangement may be configured to provide for reduced hub drag effect. The hub shell may comprise a set of seats; each magnet of the set of magnets of the magnet arrangement is within a seat of the set of seats within the hub shell. The hub shell may comprise a set of seats; each magnet of the set of magnets of the magnet arrangement is fit within a seat of the set of seats within the hub shell. The set of magnets may comprise six magnets. The ratchet ring may comprise a set of lobes; the hub shell may comprise a set of recesses; the set of lobes of the ratchet ring may be configured to fit within the set of recesses of the hub shell. The set of seats of the hub shell is fit between the set of recesses of the hub shell. The ratchet ring may comprise a set of interface surfaces. A set of interface surfaces may be fit between the set of lobes of the ratchet ring. The set of magnets of the magnet arrangement is configured to magnetize the ratchet ring at the set of interface surfaces of the ratchet ring. The ratchet ring arrangement may comprise multiple sets of ratchet rings; each of the multiple sets of ratchet rings may be configured to engage a set of pawls of the pawl system. The assembly may comprise an interface for coupling the hub body to the hub shell; the interface may comprise the ratchet mechanism. The interface may comprise the profile of pawls of the pawl system for engagement with the ratchet ring system. The interface may comprise a number of sets of pawls for mechanical engagement with gear teeth within the ratchet mechanism. The interface may comprise a number of sets of pawls for engagement with gear teeth within the ratchet mechanism by magnetic attraction. The interface may comprise a number of sets of pawls for engagement with gear teeth within the ratchet mechanism. The interface may comprise mating surfaces of a ratchet ring of the ratchet mechanism with an inner surface of the hub shell. The interface may comprise alignment of lobes of the ratchet ring with spoke flanges of the hub shell. The interface may comprise alignment of magnets between spoke flanges of the hub shell. The interface may comprise centering of magnets between spoke flanges of the hub shell. The lobes of the ratchet ring comprise load-carrying lobes configured to fit within recesses under the spoke flanges of the hub shell. The load-carrying lobes may be at the largest section of the hub shell. The magnet arrangement may be configured to magnetize the ratchet ring. An outside of the ratchet ring may be magnetized and the pawl system may be magnetically attracted into engagement at an inside of the ratchet ring. The pawl system is pulled into the ratchet ring for engagement by a magnetic force. The pawl system is pivoted into engagement with the ratchet ring by the magnetic force. The magnet arrangement may comprise a set of magnets at the outside of the ratchet ring to magnetize the ratchet ring to provide magnetic attraction of the set of pawls of the pawl system into the ratchet ring. The set of magnets may be retained in a set of pockets in the hub shell and by the ratchet ring. The set of magnets may be retained in a tight fit within the set of pockets in the hub shell. The assembly may comprise a retaining clip to hold a set of pawls in the hub body.

The present invention relates to a hub assembly for a wheel with an axle. The hub assembly for a wheel with an axle may comprise a hub shell configured to be coupled to the wheel and a hub body configured to be coupled to the axle and a ratchet mechanism comprising a ratchet ring configured to engage the hub body with the hub shell; the ratchet mechanism is configured to provide an engaged state where the hub body is configured to rotate together with the hub shell; the ratchet mechanism is configured to provide a disengaged state where the hub body is configured to rotate independently relative to the hub shell; the ratchet mechanism may be configured for magnetic engagement with the hub body. The ratchet mechanism may comprise an interface between the hub shell and the hub body. The interface may comprise the profile of pawls of the pawl system for engagement with the ratchet ring system. The interface may comprise a number of sets of pawls for engagement with gear teeth within the ratchet mechanism. The interface may comprise mating surfaces of a ratchet ring of the ratchet mechanism with an inner surface of the hub shell.

The present invention relates to a hub assembly for a wheel. The hub assembly may comprise a hub shell coupled to the wheel and a hub body configured for an axle and a ratchet mechanism comprising a ratchet ring and a pawl system and a magnet arrangement configured to provide for magnetically coupling for the ratchet mechanism of the hub body to the hub shell; the magnet arrangement may comprise a set of magnets configured to magnetically couple the pawl system to the ratchet ring; the ratchet mechanism is configured to be retained in the hub shell; the pawl system is configured to couple the ratchet ring to the hub body in an engaged state. The hub body may be configured to be engaged for rotation with the hub shell in the engaged state.

The present invention relates to a hub assembly for a wheel. The hub assembly may comprise a hub shell coupled to the wheel and a hub body configured for an axle and a ratchet mechanism comprising a ratchet ring and a pawl system and a magnet arrangement configured to provide for magnetically coupling for the ratchet mechanism of the hub body to the hub shell; the magnet arrangement may be configured to magnetically couple the pawl system to the ratchet ring; the ratchet mechanism may be configured to be retained in the hub shell; the pawl system may be configured to couple the ratchet ring to the hub body in an engaged state. The magnet arrangement may comprise a set of magnets. The set of magnets may comprise a set of disc magnets. The magnet arrangement may comprise a magnet ring. The magnet ring may comprise a set of magnetic rings. The magnet ring may be configured to clip onto the ratchet ring. The magnet ring may be configured to clip into the ratchet ring. The magnet ring may be configured to clip into a slot on the ratchet ring. The magnet ring may comprise a clip ring configured to clip onto the ratchet ring.

The present invention relates to a hub assembly for a wheel comprising a hub shell coupled to the wheel and a hub body configured for an axle and a ratchet mechanism comprising a ratchet ring and a pawl system and a magnet arrangement configured to provide for magnetically coupling for the ratchet mechanism of the hub body to the hub shell. The magnet arrangement may be configured to magnetically couple the pawl system to the ratchet ring. The ratchet mechanism may be configured to be retained in the hub shell. The pawl system may be configured to couple the ratchet ring to the hub body in an engaged state. The magnet arrangement may comprise a set of magnets; the set of magnets may comprise a set of disc magnets. The magnet arrangement may comprise a magnet ring; the magnet ring may comprise a set of magnetic rings. The magnet ring may be configured to clip onto the ratchet ring; the magnet ring may comprise a clip ring configured to clip into a slot of the ratchet ring. The magnet ring may be configured to fit on the ratchet ring. The magnet ring may be configured to fit adjacent to the ratchet ring. The magnet ring may be configured to fit within the hub shell. The magnet ring may be configured to fit within a recess in the hub shell. The magnet ring may be configured to fit within a circular recess in the hub shell. The magnet ring may comprise a continuous ring. The magnet ring may be concentric with the ratchet ring. The magnet ring may be configured to magnetize the ratchet ring. The magnet ring may be configured to magnetize the ratchet ring; The ratchet ring may be configured to magnetize each pawl of the pawl system. The magnet arrangement may comprise a magnet ring within a recess within the hub shell. The recess may comprise a groove. The magnet ring projects from the groove adjacent to the ratchet ring. The magnet arrangement may comprise a set of magnets within a set of pockets within the hub shell; the set of pockets may comprise a set of seats within the hub shell. The ratchet ring may comprise a magnetizable material; The magnet arrangement may be configured to magnetize the magnetizable material of the ratchet ring; the magnetizable material may comprise a metal. The pawl system may comprise a set of pawls; The set of pawls may comprise a magnetizable material; the set of pawls may comprise a metallic material. The ratchet ring may comprise a magnetizable material; the ratchet ring may comprise a metallic material.

The present invention relates to a hub assembly for a wheel with an axle. The assembly may comprise a hub shell configured to be coupled to the wheel and a hub body configured to be coupled to the axle and a ratchet mechanism comprising a ratchet ring configured to couple the hub body to the hub shell; the ratchet mechanism may be configured to provide an engaged state where the hub body may be configured to rotate together with the hub shell; the ratchet mechanism may be configured to provide a disengaged state where the hub body may be configured to rotate independently relative to the hub shell; the ratchet mechanism may be configured for magnetic engagement with the hub body. The engaged state may comprise a power-transmission state configured for transmission of power to the wheel and the disengaged state may comprise a free-wheel state; the engaged state may comprise a power-transmission state configured for transmission of power to the wheel from the axle and the disengaged state may comprise a free-wheel state. The ratchet ring of the ratchet mechanism may be configured to engage a set of pawls to provide the engaged state for the ratchet mechanism. The ratchet ring of the ratchet mechanism may be configured to engage a set of pawls with the hub body to provide the engaged state for the ratchet mechanism. The ratchet ring of the ratchet mechanism may be configured for magnetic engagement with the set of pawls. The set of pawls may be pivotally coupled to the hub body. The set of pawls may be configured for magnetic engagement with the ratchet ring of the ratchet mechanism. The assembly may comprise a magnet arrangement configured to provide for magnet engagement. The magnet arrangement may comprise a set of magnets. The magnet arrangement may comprise the set of magnets within the hub shell. The magnet arrangement may comprise the set of magnets within a set of seats within the hub shell. The magnet arrangement may be configured to provide for magnetization of the ratchet ring of the ratchet mechanism; the ratchet ring of the ratchet mechanism may be configured to magnetically engage a set of pawls to provide the engaged state for the ratchet mechanism. Magnetic engagement with the ratchet ring of the ratchet mechanism may comprise magnetic attraction of a set of pawls to the ratchet ring. Magnetic engagement with the ratchet ring of the ratchet mechanism may comprise magnetic attraction of the set of pawls into a set of teeth of the ratchet ring. Magnetic engagement with the ratchet ring of the ratchet mechanism may comprise magnetic attraction of the set of pawls into the set of teeth of the ratchet ring by magnetization from a magnet arrangement. Magnetic engagement with the ratchet ring of the ratchet mechanism may comprise magnetic attraction of the set of pawls into the set of teeth of the ratchet ring by magnetization from a set of magnets of the magnet arrangement. The ratchet ring may be magnetized. The ratchet ring may comprise a magnetizable material or magnetic material. The set of pawls may comprise a metallic material. The ratchet ring may comprise a metallic material. The ratchet ring may comprise a set of teeth. The ratchet mechanism may comprise a set of pawls coupled to the hub body and configured to engage the set of teeth of the ratchet ring. The ratchet ring may comprise a set of teeth configured to engage the set of pawls. In the engaged state of the ratchet mechanism the set of pawls may be in engagement with the set of teeth. In the engaged state of the ratchet mechanism the set of pawls may be magnetically drawn into engagement with the set of teeth. The assembly may comprise a magnet arrangement configured to provide for magnetic engagement of the ratchet mechanism with the hub body. The ratchet ring of the ratchet mechanism may be configured to engage a set of pawls to provide the engaged state for the ratchet mechanism. The hub body may be configured to be mechanically coupled to the hub shell through the ratchet mechanism. The hub body may be configured to be magnetically coupled for engagement with the hub shell. The hub body may be configured to be magnetically coupled at the ratchet mechanism for engagement with the hub shell. The hub body may be configured to be magnetically coupled at the ratchet ring of the ratchet mechanism for engagement with the hub shell. The ratchet mechanism may be configured to provide the engaged state where the hub body with the axle may be configured to rotate together with the hub shell with the wheel. The ratchet mechanism may be configured to provide the disengaged state where the hub body with the axle may be configured to rotate independently relative to the hub shell with the wheel. The ratchet mechanism may comprise a springless mechanism. The free-wheel state may comprise disengagement of the hub body from the hub shell and disengagement of transmission of power from the axle from the wheel. The ratchet mechanism may comprise a springless configuration; magnetic engagement of the ratchet ring may be configured to provide for reduced hub drag effect. The hub shell may be coupled to the hub body by magnetic engagement at the ratchet mechanism. The assembly of Claim further comprising a magnet arrangement configured to magnetically couple the hub body to the hub shell. The magnet arrangement may comprise a set of magnets. The hub shell may comprise a set of recesses for the set of magnets. The magnet arrangement may be configured to magnetize the ratchet ring. The ratchet ring may comprise a set of lobes. The hub shell may comprise a set of indentations; the set of indentations of the hub shell may be configured to engage the set of lobes of the ratchet ring. The ratchet ring may comprise a set of interface surfaces; each magnet in the set of magnets may be configured magnetize the ratchet ring at each interface surface of the ratchet ring. The set of interface surfaces of the ratchet ring may be positioned between the set of lobes of the ratchet ring. Each of a set of interface surfaces of the ratchet ring may be positioned between each of a set of lobes of the ratchet ring. The ratchet ring may be configured to be installed in the hub body in an aligned condition or an offset condition. Each magnet within the set of magnets may comprise a disc magnet. Each magnet within the set of magnets may comprise a bar magnet.

The present invention relates to a hub assembly for a wheel with an axle. The assembly may comprise a hub shell coupled to the wheel and a hub body configured for an axle and a ratchet mechanism comprising a ratchet ring and a pawl system and a magnet arrangement configured to provide for magnetically coupling at the ratchet mechanism of the hub body to the hub shell; the magnet arrangement may comprise a set of magnets configured to magnetically couple the pawl system to the ratchet ring; the ratchet mechanism may be configured to be retained in the hub shell; the pawl system may be configured to couple the ratchet ring to the hub body in an engaged state. The pawl system may comprise a set of pawls. The magnet arrangement may comprise magnetization of the ratchet ring. The magnet arrangement may comprise the set of magnets within the hub shell. The magnet arrangement may comprise the set of magnets within a set of pockets in the hub shell. The hub body may be configured to be engaged for rotation with the hub shell in the engaged state. The hub body may be configured to be disengaged for rotation independent of the hub shell in a disengaged state. The hub body may be configured to be engaged for rotation with the hub shell in the engaged state with the pawl system magnetically attracted into engagement with the ratchet ring. The hub body may be configured to be engaged for rotation with the hub shell in the engaged state; the pawl system may be magnetically drawn into mechanical engagement with the ratchet ring. The ratchet mechanism may be configured to be magnetically drawn into engagement of the hub body and the hub shell. The hub body may be configured to be magnetically coupled at the ratchet ring of the ratchet mechanism for engagement with the hub shell. The hub body may be configured to be engaged for rotation with the hub shell in the engaged state; the pawl system may be magnetically drawn into engagement with the ratchet ring. The hub body may be configured to be magnetically coupled by the pawl system at the ratchet ring of the ratchet mechanism for engagement with the hub shell. The pawl system may comprise a set of pawls configured to couple the ratchet ring to the hub body by engagement with a set of teeth on the ratchet ring. The ratchet ring mechanism may be configured to be retained in the hub shell by a locking ring. The pawl system may comprise a set of pawls pivotally coupled to the hub body. Rotation of the hub shell may comprise (a) rotation with engagement with the hub body when the pawl system may be engaged with the ratchet ring arrangement and (b) rotation without engagement with the hub body when the pawl system may be disengaged from the ratchet ring arrangement. The magnet arrangement may be configured to provide for reduced hub drag effect. The hub shell may comprise a set of seats; each magnet of the set of magnets of the magnet arrangement may be within a seat of the set of seats within the hub shell. The hub shell may comprise a set of seats; each magnet of the set of magnets of the magnet arrangement may be fit within a seat of the set of seats within the hub shell. The set of magnets may comprise six magnets. The ratchet ring may comprise a set of lobes; the hub shell may comprise a set of recesses; the set of lobes of the ratchet ring may be configured to fit within the set of recesses of the hub shell. The set of seats of the hub shell may be fit between the set of recesses of the hub shell. The ratchet ring may comprise a set of interface surfaces. A set of interface surfaces may be fit between the set of lobes of the ratchet ring. The set of magnets of the magnet arrangement may be configured to magnetize the ratchet ring at the set of interface surfaces of the ratchet ring. The ratchet ring arrangement may comprise multiple sets of ratchet rings; each of the multiple sets of ratchet rings may be configured to engage a set of pawls of the pawl system. The assembly may comprise an interface for coupling the hub body to the hub shell; the interface may comprise the ratchet mechanism. The interface may comprise the profile of pawls of the pawl system for engagement with the ratchet ring system. The interface may comprise a number of sets of pawls for mechanical engagement with gear teeth within the ratchet mechanism. The interface may comprise a number of sets of pawls for engagement with gear teeth within the ratchet mechanism by magnetic attraction. The interface may comprise a number of sets of pawls for engagement with gear teeth within the ratchet mechanism. The interface may comprise mating surfaces of a ratchet ring of the ratchet mechanism with an inner surface of the hub shell. The interface may comprise alignment of the lobes of the ratchet ring with spoke flanges of hub shell. The interface may comprise alignment of magnets between spoke flanges of the hub shell. The interface may comprise centering of magnets between spoke flanges of the hub shell. The lobes may comprise load-carrying lobes configured to fit within recesses under the spoke flanges of the hub shell. The load-carrying lobes may be at the largest section of the hub shell. The ratchet ring may be magnetized. The magnet arrangement may be configured to magnetize the ratchet ring. An outside of the ratchet ring may be magnetized and the pawl system may be magnetically attracted into engagement at an inside of the ratchet ring. The pawl system may be pulled into the ratchet ring for engagement by a magnetic force. The pawl system may be pivoted into engagement with the ratchet ring by the magnetic force. The magnet arrangement may comprise a set of magnets at the outside of the ratchet ring to magnetize the ratchet ring to provide magnetic attraction of the set of pawls of the pawl system into the ratchet ring. The set of magnets may be retained in a set of pockets in the hub shell and by the ratchet ring. The set of magnets may be retained in a tight fit within the set of pockets in the hub shell. The assembly may comprise a retaining clip to hold the set of pawls in the hub body.

The present invention relates to a hub assembly for a wheel with an axle. The assembly may comprise a hub shell configured to be coupled to the wheel and a hub body configured to be coupled to the axle and a ratchet mechanism comprising a ratchet ring configured to engage the hub body with the hub shell; the ratchet mechanism may be configured to provide an engaged state where the hub body may be configured to rotate together with the hub shell; the ratchet mechanism may be configured to provide a disengaged state where the hub body may be configured to rotate independently relative to the hub shell; the ratchet mechanism may be configured for magnetic engagement with the hub body. The ratchet mechanism may comprise an interface between the hub shell and the hub body. The interface may comprise the profile of pawls of the pawl system for engagement with the ratchet ring system. The interface may comprise a number of sets of pawls for engagement with gear teeth within the ratchet mechanism. The interface may comprise mating surfaces of a ratchet ring of the ratchet mechanism with an inner surface of the hub shell.

The present invention relates to a hub assembly for a wheel with an axle. The assembly may comprise a hub shell coupled to the wheel and a hub body configured for an axle and a ratchet mechanism comprising a ratchet ring and a pawl system and a magnet arrangement configured to provide for magnetically coupling for the ratchet mechanism of the hub body to the hub shell; the magnet arrangement may comprise a set of magnets configured to magnetically couple the pawl system to the ratchet ring; the ratchet mechanism may be configured to be retained in the hub shell; the pawl system may be configured to couple the ratchet ring to the hub body in an engaged state. The hub body may be configured to be engaged for rotation with the hub shell in the engaged state.

The present invention relates to a hub assembly for a wheel comprising a hub shell coupled to the wheel and a hub body configured for an axle; the hub shell is coupled to the hub body by a ratchet mechanism; the ratchet mechanism may comprise a ratchet ring arrangement and a pawl system; rotation of the hub shell may comprise (a) rotation with engagement with the hub body when the pawl system is engaged with the ratchet ring arrangement and (b) rotation without engagement with the hub body when the pawl system is disengaged from the ratchet ring arrangement; and maximum rotation of the hub shell before engagement of the hub body is a configured to be determined by at least one of (a) a number of ratchet rings in the ratchet ring arrangement; (b) a number of gear teeth of each ratchet ring of the ratchet ring arrangement; (c) whether gear teeth of each ratchet ring of the ratchet ring arrangement are in an aligned condition or an offset condition; (d) a number of sets of pawls of the pawl system for engagement with a gear teeth of a ratchet ring in the ratchet ring arrangement. The pawl system may comprise multiple sets of pawls configured to engage the ratchet ring arrangement. The pawl system may comprise adjacent sets of pawls configured in an aligned condition for engagement with the ratchet ring arrangement. The ratchet ring arrangement may comprise adjacent ratchet rings configured for engagement with the pawl system; the ratchet ring arrangement is in the aligned condition when gear teeth of adjacent ratchet rings of the ratchet ring arrangement are in alignment; the ratchet ring arrangement is in the offset condition when gear teeth of adjacent ratchet rings of the ratchet ring arrangement are offset. In the offset condition maximum rotation before engagement of the hub shell with the hub body is reduced in comparison with the aligned condition. The ratchet ring arrangement may comprise multiple sets of ratchet rings; with each ratchet ring in an offset condition a number of effective gear teeth per cycle of rotation of each ratchet ring arrangement is greater than the number of gear teeth of each ratchet ring; variation of the number of effective gear teeth engaged provides variation of performance characteristics at the wheel. Each of the multiple sets of ratchet rings may be configured to engage a set of pawls of the pawl system.

The present invention relates to a hub assembly for a wheel comprising a hub shell coupled to the wheel and a hub body configured for an axle; the hub shell is coupled to the hub body by a ratchet mechanism; the ratchet mechanism is configured to provide an engaged state where the hub body with the axle is configured to rotate together with the hub shell with the wheel; the ratchet mechanism is configured to provide a disengaged state where the hub body with the axle is configured to rotate independently relative to the hub shell with the wheel; the ratchet mechanism may comprise a set of pawls and a set of ratchet rings comprising a set of teeth; in the engaged state for a ratchet ring a set of teeth is configured to engage a set of pawls; the engaged state may comprise a power-transmission state configured for transmission of power to the wheel; and the disengaged state may comprise a free-wheel state. The set of ratchet rings may be configured to be installed in the hub body in an aligned condition or an offset condition. When the ratchet rings are configured in an offset condition the ratchet mechanism may be configured to facilitate a generally more responsive transition between the disengaged state and the engaged state. The set of ratchet rings may comprise multiple sets of ratchet rings; with each ratchet ring in the set of ratchet rings in a offset condition a number of effective gear teeth per cycle of rotation of each ratchet ring arrangement is greater than the number of gear teeth on each separate ratchet ring.

The present invention relates to a hub assembly for a wheel comprising a hub shell coupled to the wheel a hub body configured for an axle; the hub shell may be coupled to the hub body by a ratchet mechanism; the ratchet mechanism may comprise a ratchet ring system and a pawl system; the pawl system may be configured for engagement with the ratchet ring system; rotation of the hub shell may comprise (a) rotation with engagement with the hub body and (b) rotation without engagement with the hub body. The ratchet ring system may comprise adjacent ratchet rings configured for engagement with the pawl system; the ratchet ring system is in an aligned condition when gear teeth of adjacent ratchet rings of the ratchet ring system are in alignment; the ratchet ring system is in an offset condition when gear teeth of adjacent ratchet rings of the ratchet ring system are offset. The ratchet mechanism is in the offset condition maximum rotation before engagement of the hub shell with the hub body is reduced in comparison with the aligned condition. In the aligned condition wider load distribution within the ratchet mechanism is enhanced in comparison with the offset condition. The pawl system may comprise a number of sets of pawls for engagement with a ratchet ring of the ratchet ring system. Rotation of the hub shell may comprise (a) rotation with engagement with the hub body when the pawl system is engaged with the ratchet ring system and (b) rotation without engagement with the hub body when the pawl system is disengaged from the ratchet ring system. Maximum rotation of the hub shell before engagement of the hub body is a product of at least one of (a) a number of ratchet rings; (b) a number of gear teeth of each ratchet ring; (c) whether gear teeth of each ratchet ring are in an aligned condition or an offset condition; (d) a number of sets of pawls for engagement with gear teeth of a ratchet ring. The ratchet mechanism may comprise an interface between the hub shell and the hub body; the interface is configured for an engaged state and a disengaged state; the interface is configured for maximum rotation between the disengaged state and the engaged state; in the engaged state a set of ratchet rings of the ratchet ring system is engaged with a set of pawls of the pawl system. The interface may comprise the profile of pawls of the pawl system for engagement with the ratchet ring system. The interface may comprise a number of sets of pawls for engagement with gear teeth within the ratchet mechanism. The interface may comprise mating surfaces of a ratchet ring of the ratchet mechanism with an inner surface of the hub shell.

The present invention relates to an improved wheel hub assembly that may comprise a hub shell for a wheel and coupled to a hub body with an axle by a ratchet mechanism and configured to provide an engaged state where the hub body/axle and the hub shell/wheel rotate together and a disengaged state where the hub body/axle may rotate independently relative to hub shell/wheel; the ratchet mechanism may comprise a set of ratchet rings configured with a set of teeth and a sets/groups of pawls configured to engage/disengage the teeth of a ratchet ring; the ratchet rings may be configured/installed in the hub body in an aligned condition or an offset condition; when the ratchet rings are configured in an offset condition the ratchet mechanism may be configured to facilitate a generally more responsive transition between the disengaged state and the engaged state for the hub body/axle and hub shell/wheel.

### FIGURES

FIG. 1 is a schematic perspective view of a bicycle with a wheel hub assembly according to an exemplary embodiment.

FIG. 2A is a schematic perspective view of a wheel for a vehicle such as a bicycle with a wheel hub assembly according to an exemplary embodiment.

FIG. 2B is a schematic exploded perspective view of wheel hub assembly on a wheel according to an exemplary embodiment.

FIG. 3 is a schematic exploded perspective view of a wheel hub assembly for a wheel according to an exemplary embodiment.

FIG. 4 is a schematic diagram of operation of the ratchet mechanism of a wheel hub assembly for a wheel according to an exemplary embodiment.

FIG. 5 is a schematic diagram of operation of the ratchet mechanism of a wheel hub assembly for a wheel according to an exemplary embodiment.

FIG. 6 is a schematic perspective view of a pawl for a ratchet mechanism of a wheel hub assembly for a wheel according to an exemplary embodiment.

FIG. 7 is a schematic perspective view of a magnet for a magnet arrangement for a ratchet mechanism of a wheel hub assembly for a wheel according to an exemplary embodiment.

FIG. 8 is a schematic cross-section side elevation view of a wheel hub assembly for a wheel according to an exemplary embodiment.

FIG. 9 is a schematic exploded cross-section side elevation view of a wheel hub assembly for a wheel according to an exemplary embodiment.

FIG. 10 is a schematic exploded partial perspective view of a wheel hub assembly for a wheel according to an exemplary embodiment.

FIG. 11A is a schematic diagram of operation of the ratchet mechanism of a wheel hub assembly for a wheel according to an exemplary embodiment.

FIG. 11B is a schematic perspective view of a wheel hub assembly for a wheel according to an exemplary embodiment.

FIG. 11C is a schematic exploded partial perspective view of a ratchet mechanism for a wheel hub assembly for a wheel according to an exemplary embodiment.

FIG. 12A is a schematic diagram of operation of the ratchet mechanism of a wheel hub assembly for a wheel according to an exemplary embodiment.

FIG. 12B is a schematic perspective partial view of a wheel hub assembly for a wheel according to an exemplary embodiment.

FIG. 12C is a schematic exploded partial perspective view of a ratchet mechanism for a wheel hub assembly for a wheel according to an exemplary embodiment.

FIG. 13A is a schematic diagram of operation of the ratchet mechanism of a wheel hub assembly for a wheel according to an exemplary embodiment.

FIG. 13B is a schematic perspective partial view of a wheel hub assembly for a wheel according to an exemplary embodiment.

FIG. 13C is a schematic exploded side elevation view of a wheel hub assembly for a wheel according to an exemplary embodiment.

FIG. 14A is a schematic diagram of operation of the ratchet mechanism of a wheel hub assembly for a wheel according to an exemplary embodiment.

FIG. 14B is a schematic perspective partial view of a wheel hub assembly for a wheel according to an exemplary embodiment.

FIG. 14C is a schematic exploded partial perspective view of a ratchet mechanism for a wheel hub assembly for a wheel according to an exemplary embodiment.

FIG. 15 is a schematic diagram of operation of the ratchet mechanism of a wheel hub assembly for a wheel according to an exemplary embodiment.

FIG. 16 is a schematic diagram of operation of the ratchet mechanism of a wheel hub assembly for a wheel according to an exemplary embodiment.

FIG. 16A is a schematic diagram of a ratchet mechanism of a wheel hub assembly for a wheel according to an exemplary embodiment.

FIGS. 16B and 16C are schematic perspective views of a ratchet mechanism of a wheel hub assembly for a wheel according to an exemplary embodiment.

FIG. 16D is a schematic diagram of the ratchet mechanism of a wheel hub assembly for a wheel according to an exemplary embodiment.

FIG. 17A is a schematic diagram of operation of the ratchet mechanism of a wheel hub assembly for a wheel according to an exemplary embodiment.

FIG. 17B is a schematic exploded side elevation view of a wheel hub assembly for a wheel according to an exemplary embodiment.

FIG. 17C is a schematic exploded partial perspective view of a ratchet mechanism for a wheel hub assembly for a wheel according to an exemplary embodiment.

FIG. 17D is a schematic exploded side elevation view of a wheel hub assembly for a wheel according to an exemplary embodiment.

FIGS. 17E and 17F are schematic perspective views of a ratchet mechanism of a wheel hub assembly for a wheel according to an exemplary embodiment.

FIG. 17G is a schematic detail side elevation view of a wheel hub assembly for a wheel according to an exemplary embodiment.

FIG. 17H is a schematic detail side elevation view of a wheel hub assembly for a wheel according to an exemplary embodiment.

FIG. 18 is a schematic diagram/graphical representation of operation of a wheel hub assembly for a wheel according to an exemplary embodiment.

### DESCRIPTION

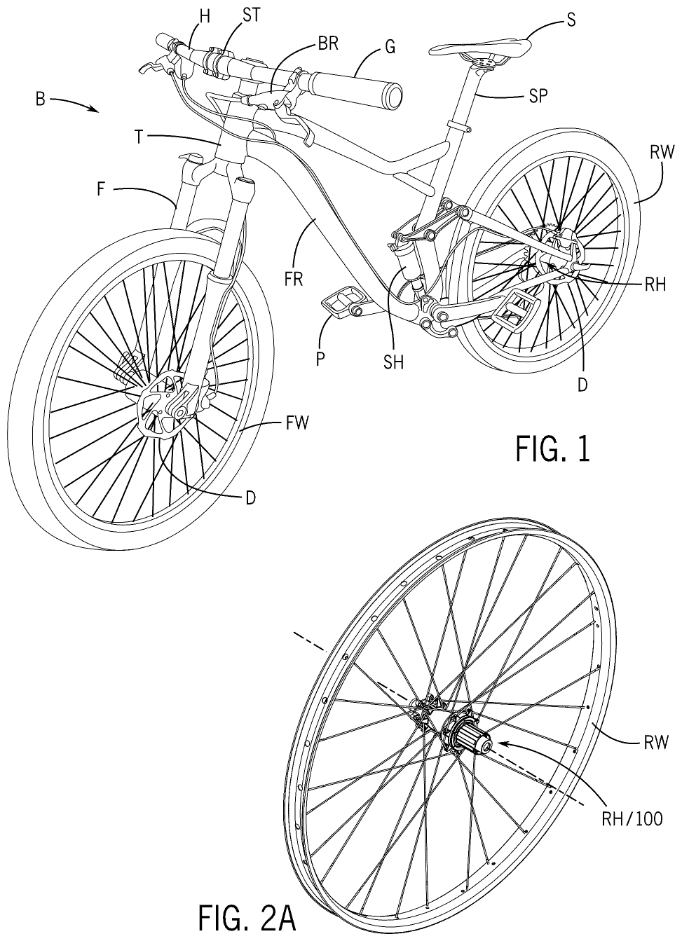

Referring to FIG. 1, a bicycle B (such as a mountain bike) is shown schematically according to an exemplary embodiment providing an arrangement of parts/components including a frame FR with a steering tube T and a seat post SP (with seat S) and a set of wheels comprising front wheel FW with a front fork assembly F and rear wheel RW coupled to the frame FR and through a rear shock absorber SH (of a suspension system) and a set of pedals P; the bicycle provides handlebar H (coupled by stem ST to front wheel FW through front fork assembly F and through steering tube T) with a grip G and controls for a brake system BR (with reservoir) coupled to a brake disc D (e.g. rotor at/on each of front wheel FW and rear wheel RW).

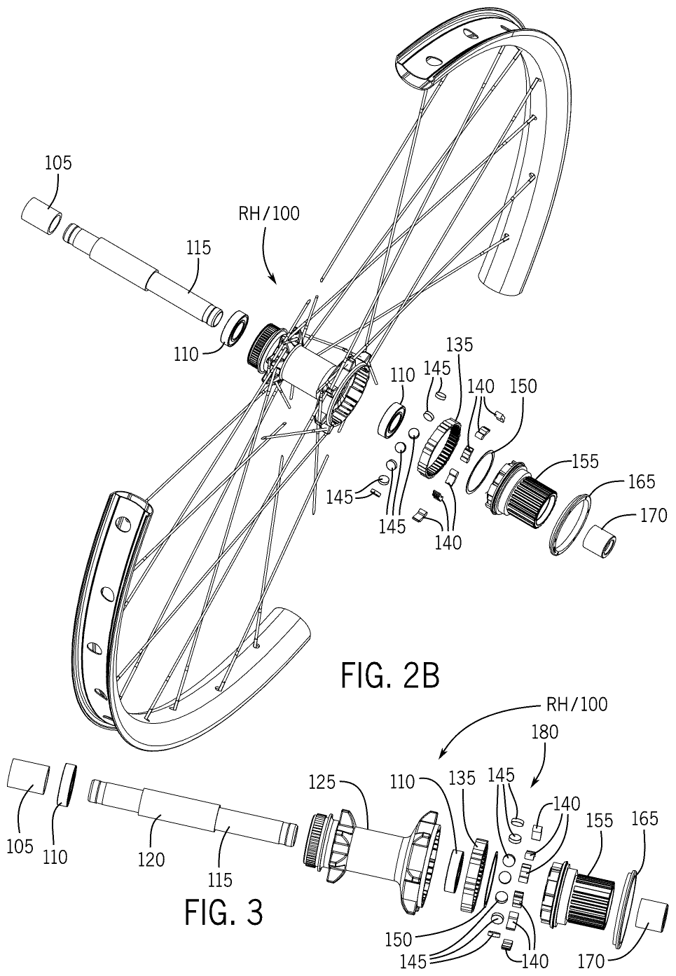

As shown schematically according to an exemplary embodiment in FIGS. 1, 2A-2B and 3, the rear wheel RW comprises a wheel hub assembly RH/100; the wheel hub assembly RH/100 comprises a central tube structure shown as a hub shell 125 configured to provide structure for the wheel (e.g. with interconnection for wheel spokes shown as spoke flange for securing the wheel rim) and a free hub body 155 with an axle 115 within the hub shell 125; the free hub body 155 and axle 115 are installed and coupled within the hub shell 125 by a ratchet mechanism 180 and configured for connection to the drive system for the bicycle. (As indicated schematically in FIGS. 1 and 2A-2B, the wheel hub assembly may provide for connection to related systems such as the brake system through mounting tabs for the brake disc for the wheel.)

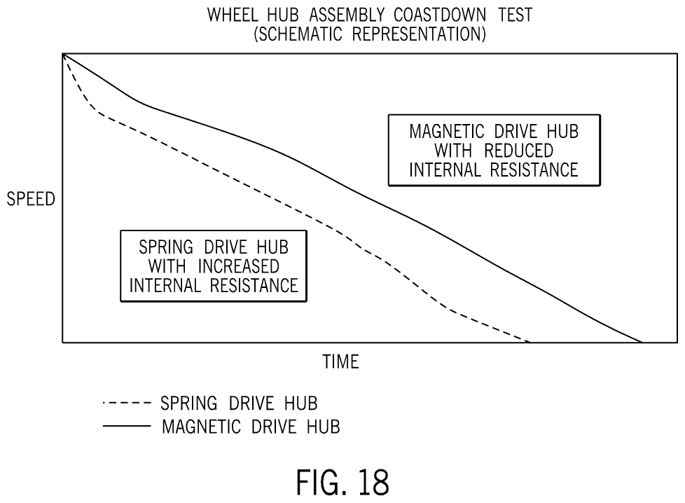

As shown schematically according to an exemplary embodiment in FIGS. 1 and 2A, wheel hub assembly RH/100 provides wheel hub with a free hub body 155 with axle 115 within the axial center of the rear wheel RW (e.g. configured for rotary motion/rotation about an aligned center axis); the rear wheel/wheel hub assembly are configured for rotation to facilitate forward motion of the bicycle (e.g. with power supplied from a drive system through the free hub body to the rear wheel). As shown schematically according to an exemplary embodiment in FIGS. 1 and 2A-2B, the ratchet mechanism 180 of the wheel hub assembly RH/100 is configured (a) to transmit power in a forward direction from the free hub body/axle for forward motion/rotation of the wheel (e.g. by mechanical engagement/coupling) when the wheel is driven/moved forward (e.g. with power supplied from the drive system (such as gear train/cluster/cassette) to the free hub body/axle such as from an operator through the pedals and/or from a motor, etc.) and (b) to allow free rotary motion/rotation of the free hub body/axle relative to the wheel other than when driven/moved in the forward direction (e.g. by mechanical disengagement/decoupling) when the wheel hub/axle is moved in a reverse direction or with motion slowed/stopped relative to the wheel (e.g. during gliding, coasting, “free-wheeling”, braking. slowing, shifting, etc.). See also FIG. 18 (schematic representation of internal resistance of coasting wheel).

As shown schematically according to an exemplary embodiment in FIGS. 1, 2A-2B and 3, the wheel hub assembly 100 provides an axial structure at the center of the wheel that is on one side/end connected to the drive system and the ratchet mechanism through the free hub body/axle (e.g. providing what is considered to be the “drive side” for components).

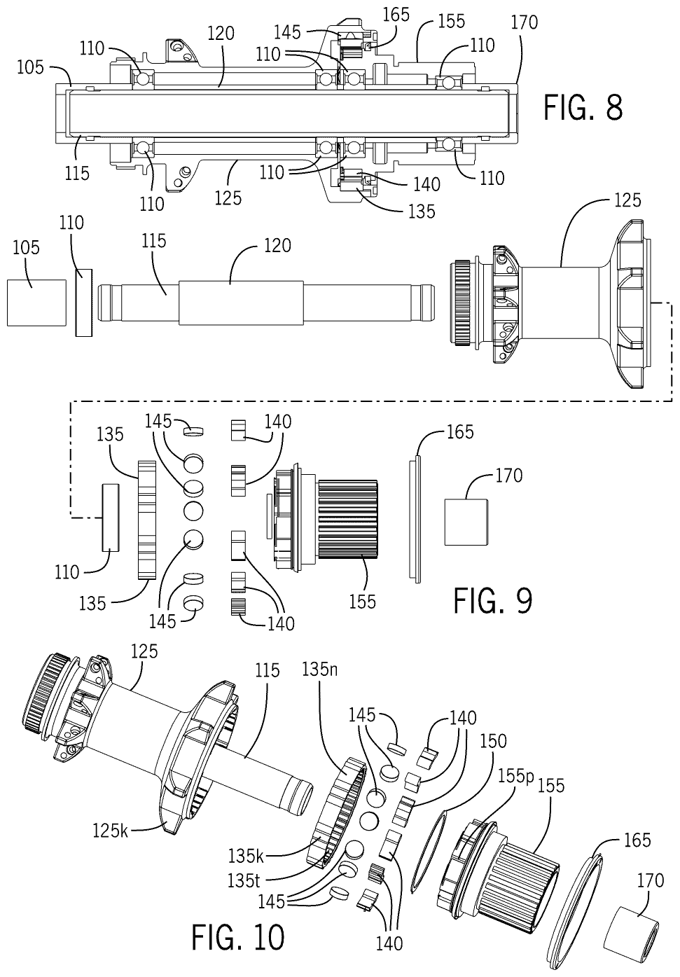

As shown schematically according to an exemplary embodiment in FIGS. 2B, 3, 8, 9, 10, the wheel hub assembly 100 comprises a set of end caps comprising end cap 105 (e.g. on non-drive side) an end cap 180 (e.g. on drive side) for the hub shell 125; as shown schematically in FIGS. 3, 5 and 6, the wheel hub assembly 100 is assembled with end cap 105 (non-drive side) and a seal shown as O-ring and a set of bearings 110 an a spacer 120 for the axle 115 for free hub body 155 installed through the ratchet mechanism 180 and within hub shell 125 with a threaded locking ring shown as ratchet cap 165 and an end cap 180 (drive side). See also 2B, 3, 8, 9, 10, 11B-11C, 12B-12C, 13B-13C and 14B-14C.

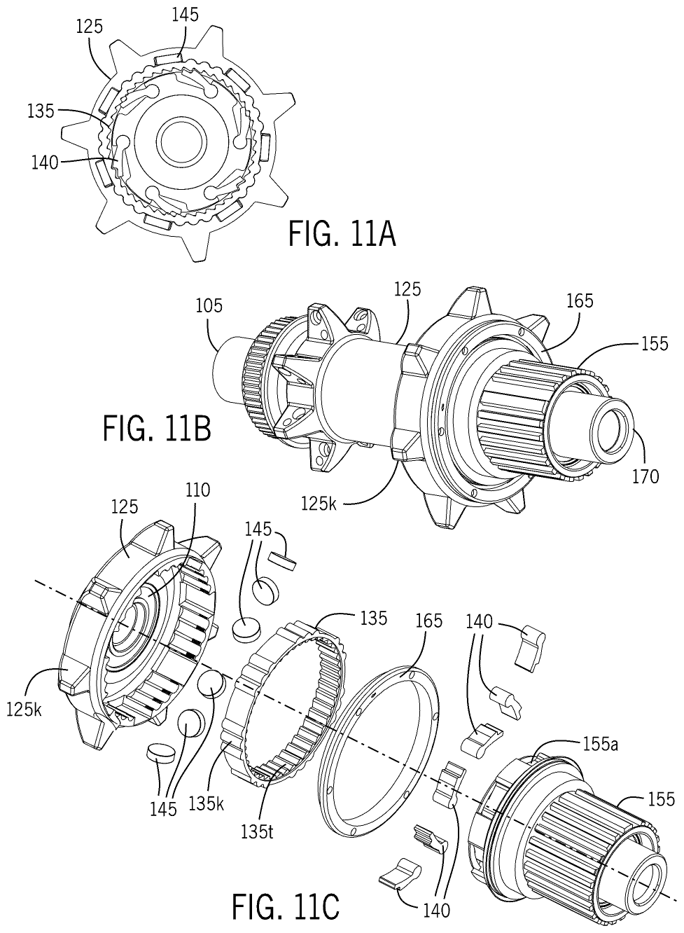

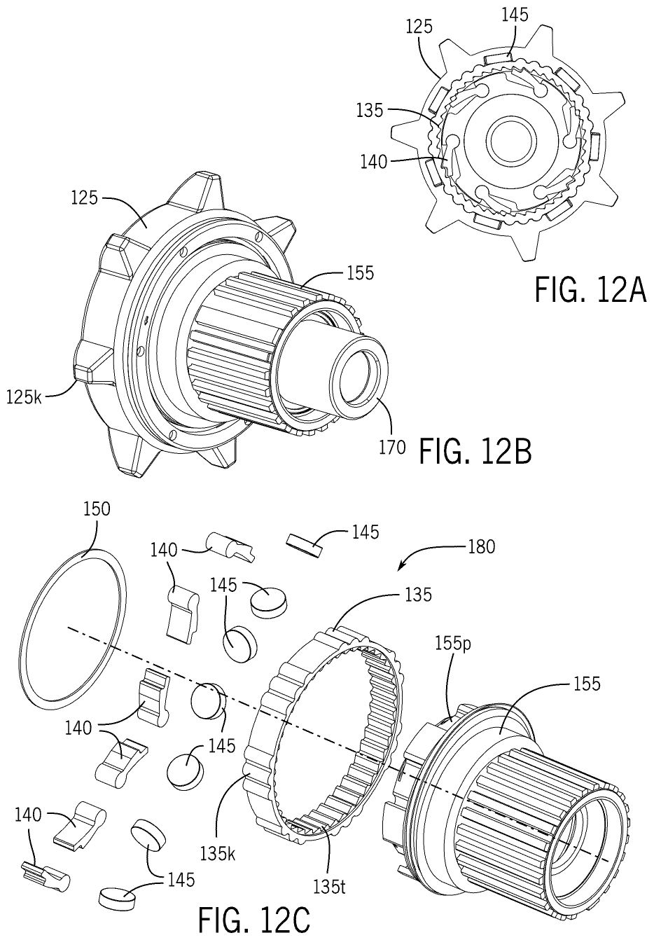

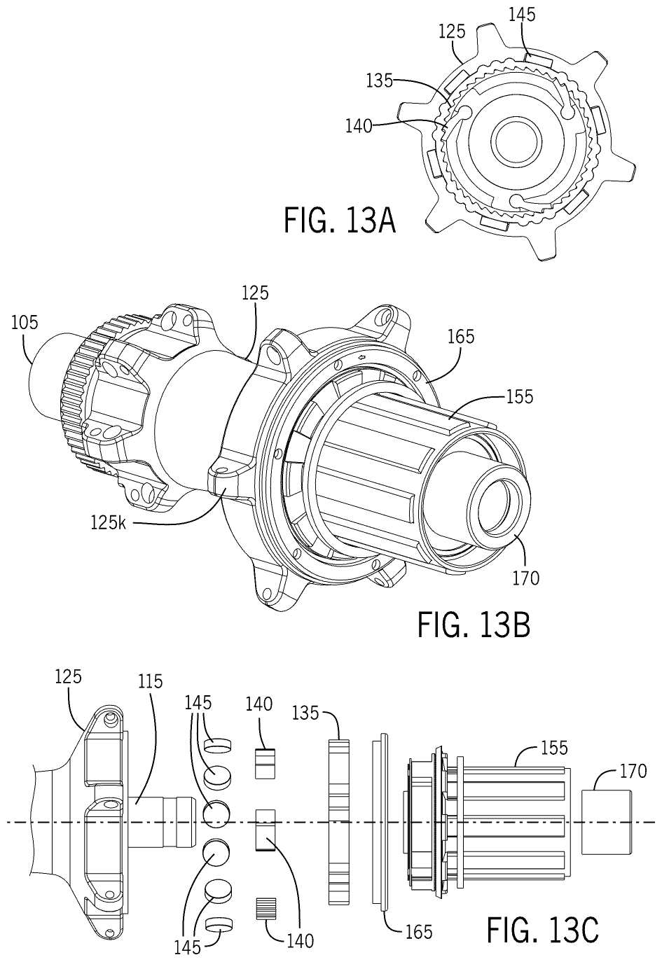

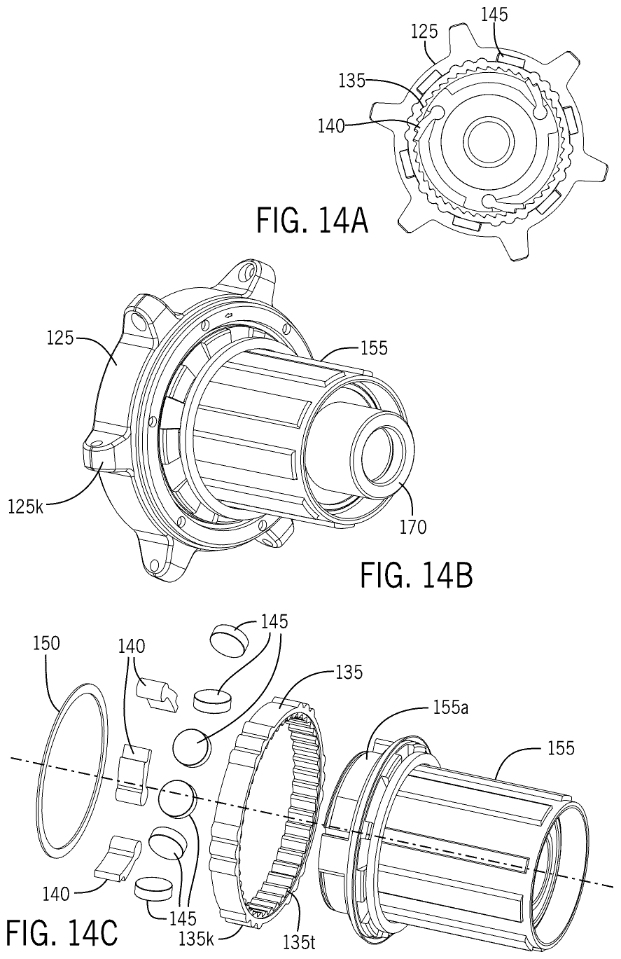

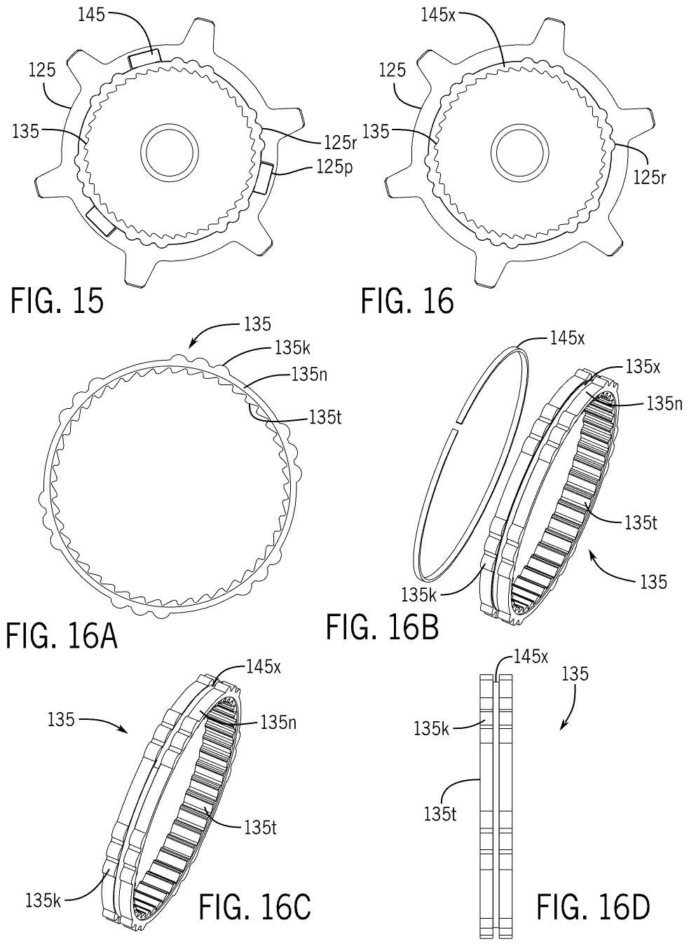

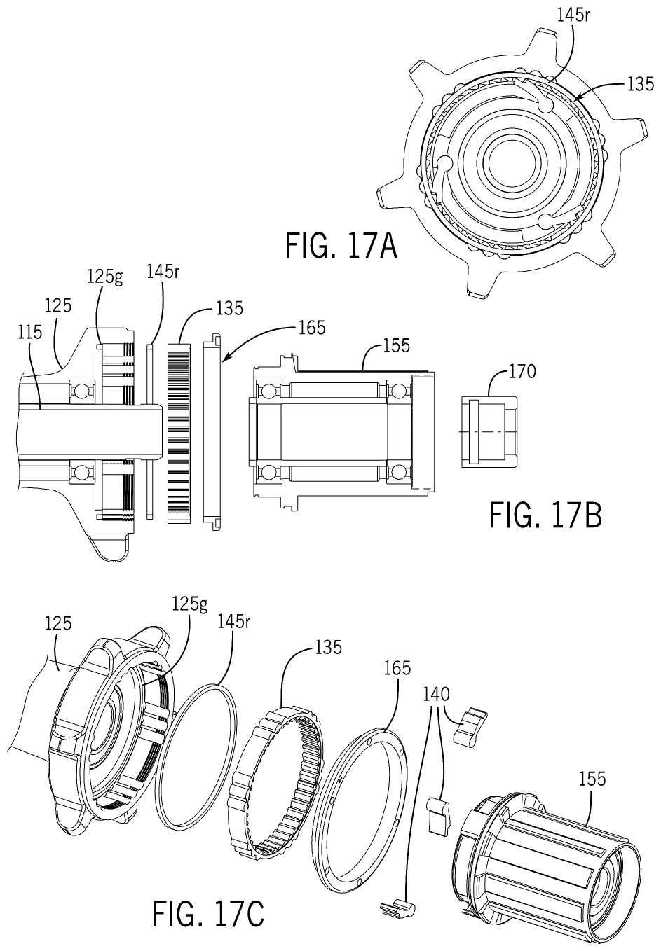

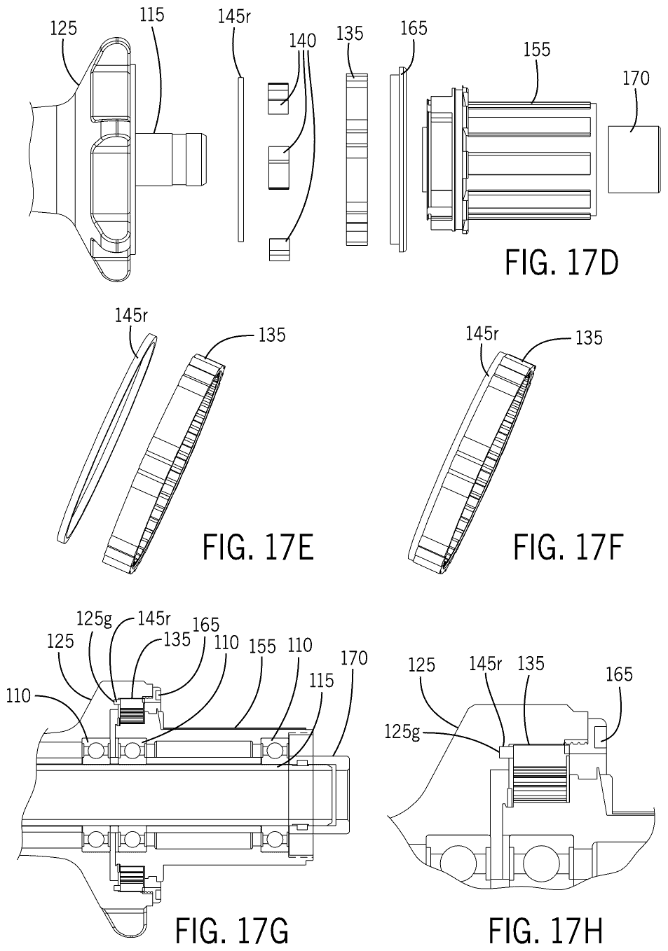

As shown schematically according to an exemplary embodiment in FIGS. 2B, 3, 8, 9, 10, 11B-11C, 12B-12C, 13B-13C and 14B-14C, the ratchet mechanism 180 of the wheel hub assembly comprises a ratchet ring 135 and with a set of features on the internal perimeter shown as gear teeth 135t configured to engage sets/groups of pawls 140 (that may be configured in multiple groups/sets). See also FIGS. 16A-16D. As schematically shown in FIGS. 2B, 3, 4, 5, 6, 7, 8, 9 and 10, the pawls 140 (e.g. in sets configured to engage the ratchet ring) are retained by magnetic attraction comprising a magnetic force MF from a magnet arrangement comprising magnets 145; magnets 145 are provided in a set of seats shown as pockets 155p on the free hub body 155; a seal is provided to engage a seal groove 155b on free hub body 155. See also FIGS. 3. 4, 5 and 7 (configuration of magnets discs 145 according to an exemplary embodiment) and FIGS. 16 and 16A-16D (configuration of magnet ring 145x according to an exemplary embodiment) and FIGS. 17A-17H (configuration of magnet ring 145r according to an exemplary embodiment). As shown schematically in FIGS. 2B, 3, 4, 5, 8, 9, 10, 11A-11C, 12A-12C, 13A-13C, and 14A-14C, the ratchet ring 135 of the ratchet mechanism 180 provides a set of features/projections on the external perimeter shown as lobes 135k that are engaged/secured on corresponding features within the interior perimeter of the hub shell 125 shown as recesses 125r to install/retain the ratchet ring in the wheel hub assembly (the assembly may comprise a variety of configurations of a ratchet ring with external perimeter/lobes to engage the interior of perimeter of a hub shell). See also FIGS. 15, 16, 16A-16D and 17A-17H.

According to an exemplary embodiment shown schematically in FIGS. 2B, 3, 8, 9, 10, 11B-11C, 12B-12C, 13B-13C and 14B-14C, the hub shell 125 may be coupled to the hub body 155 by magnetic engagement at the ratchet mechanism 180; the assembly may comprise a magnet arrangement 145 configured to magnetically couple the hub body to the hub shell; the magnet arrangement may comprise a set of magnets 145; the hub shell 125 may comprise a set of recesses 125r for the set of magnets 145; the magnet arrangement may be configured to magnetize the ratchet ring; the ratchet ring 135 may comprise a set of lobes 135k; the hub shell may comprise a set of indentations 125r; the set of indentations 125r of the hub shell 125 may be configured to engage the set of lobes 135k of the ratchet ring 135; the ratchet mechanism 180 with ratchet ring 135 may comprise an interface comprising a set of interface surfaces 135n; each magnet 145 in the set of magnets may be configured magnetize the ratchet ring 135 at each interface surface 135n of the ratchet ring 135. The set of interface surfaces 135n of the ratchet ring 135 may be positioned between the set of lobes 135k of the ratchet ring 135; each of a set of interface surfaces 135n of the ratchet ring may be positioned between each of a set of lobes 135k of the ratchet ring. The ratchet ring may be configured to be installed in the hub body in an aligned condition or an offset condition.

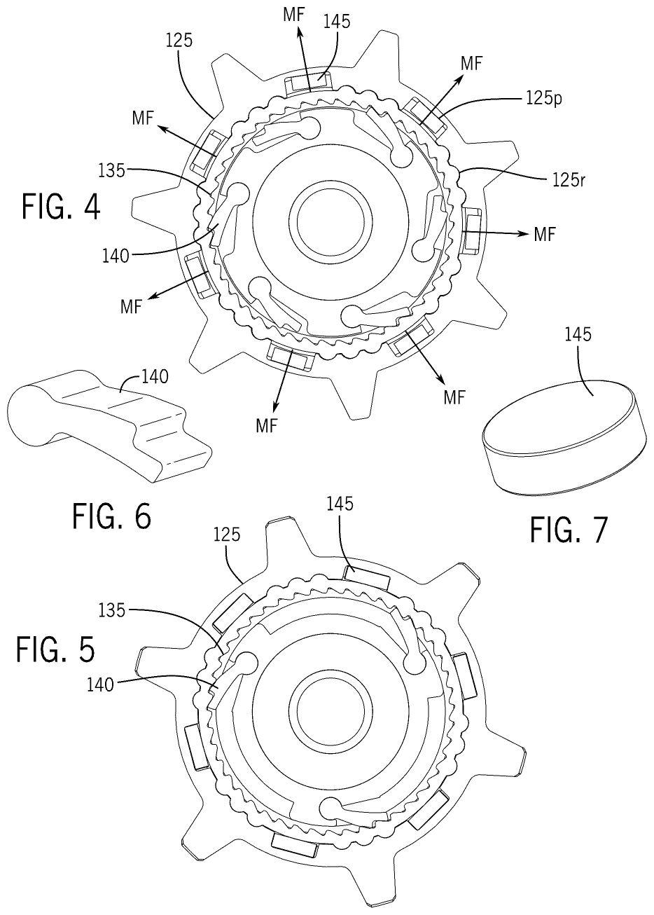

As indicated schematically according to an exemplary embodiment in FIGS. 2B, 3, 4, 5, 7, 15, 16, 16A-16D and 17A-17H, a magnet arrangement is provided for the hub assembly; the magnet arrangement may comprise a magnet or set of magnets is a variety of forms and sizes and number and types; each magnet within the set of magnets may comprise a disc magnet (see FIG. 7); each magnet within the set of magnets may comprise a bar magnet; the magnet arrangement may be provided in the hub shell (see FIGS. 4, 5, 15 and 17A); the magnet arrangement may be provided in the ratchet ring (see FIGS. 16 and 16A-16D); the magnet arrangement may comprise a ring magnet (see FIGS. 16A-16D and 17A-17H); the magnet arrangement may comprise a ring magnet configured to fit onto the ratchet ring (see FIGS. 16A-16D); the magnet arrangement may comprise a ring magnet configured to fit adjacent to the ratchet ring (see FIGS. 17A-17H).

As indicated schematically according to an exemplary embodiment in FIGS. 16 and 16A-16D, the ratchet mechanism may comprise a ratchet ring 135 configured with a slot 135x to contain a magnet arrangement comprising a magnet ring 145x. The hub shell may comprise a set of seats; each magnet of the set of magnets of the magnet arrangement is within a seat of the set of seats within the hub shell. The hub shell may comprise a set of seats; each magnet of the set of magnets of the magnet arrangement is fit within a seat of the set of seats within the hub shell. The set of magnets may comprise six magnets; the set of magnets may comprise three magnets; the set of magnets may comprise a set of magnet rings configured to fit on the ratchet ring; the magnet arrangement may comprise a single magnet ring configured to fit on the ratchet ring. See also FIGS. 17A-17H (magnet ring configured to fit within hub shell adjacent to ratchet ring).

As indicated schematically according to an exemplary embodiment in FIGS. 2B, 3, 4, 5, 6, 7, 8, 9, 10, 11A, 12A, 13A, 14A, 15 and 16, an outside of the ratchet ring 135 may be magnetized and the pawl system 140 may be magnetically attracted into engagement at an inside of the ratchet ring. The pawl system is pulled into the ratchet ring for engagement by a magnetic force MF from magnet arrangement 145. The pawl system is pivoted into engagement with the ratchet ring by the magnetic force MF.

As shown schematically according to an exemplary embodiment in FIGS. 2B, 3, 4, 5, 6, 8, 9, 10, 11A-11C, 12A-12C, 13A-13C and 14A-14C, the ratchet ring arrangement comprises multiple groups/sets of pawls. See also FIGS. 15 and 16. As shown schematically according to an exemplary embodiment in FIGS. 2B, 3, 4, 5 and 6, each pawl 140 is configured with a profile/shape providing surface (e.g. including a ramped/cam surface) configured to engage and disengage with gear teeth 135t of the ratchet ring 135.

As shown schematically in FIGS. 3, 4, 5, 6, 11A-11C, 12A-12C, 13A-13C and 14A-14C, each pawl 140 is provided with a base configured to provide a pivot within a seat 155p of free hub body 155 (e.g. lobes/keys to allow pivoting movement for engagement and disengagement under the action of the magnet and gear teeth of the ratchet ring during rotation) and a body with a curved cam/surface (to facilitate disengagement from gear teeth of the ratchet ring) and an end profile providing an interface (e.g. seat comprising two teeth to engage/mesh) with the gear teeth on the ratchet ring. See also FIGS. 15 and 16.

As indicated schematically in FIG. 4, 5, 11A, 12A, 13A, 14A, when the axle/free hub body with pawls 140 drawn into engagement by magnetic attraction/force MF provided by the magnet arrangement comprising magnets 145 at ratchet ring 135 is rotated in a forward direction (relative to the hub shell/wheel), the cam surface of each pawl is configured to engage the gear teeth of the ratchet ring (and drive/engage the wheel); when the axle/free hub body with pawls 140 is stopped or rotated in an opposite direction (relative to the hub shell/wheel), the cam surface of each pawl is configured to disengage (e.g. “slip” the gears/gear teeth) the gear teeth of the ratchet ring (and decouple/disengage the wheel). See also FIGS. 15 and 16 (magnet arrangement comprising magnet ring 145x providing magnetic attracting/force).

According to an exemplary embodiment as indicated schematically in FIGS. 2B, 3, 4, 5, 7, 15, 16, 16A-16D and 17A-17H, a hub assembly for a wheel may comprise a hub shell coupled to the wheel and a hub body configured for an axle and a ratchet mechanism comprising a ratchet ring and a pawl system and a magnet arrangement configured to provide for magnetically coupling for the ratchet mechanism of the hub body to the hub shell; the magnet arrangement may be configured to magnetically couple the pawl system to the ratchet ring; the ratchet mechanism may be configured to be retained in the hub shell; the pawl system may be configured to couple the ratchet ring to the hub body in an engaged state.

According to an exemplary embodiment as indicated schematically in FIGS. 2B, 3, 4, 5, 7 and 15, the magnet arrangement may comprise a set of magnets; the set of magnets may comprise a set of disc magnets. According to an exemplary embodiment as indicated schematically in FIGS. 2B, 16, 16A-16D and 17A-17H, the magnet arrangement may comprise a magnet ring and/or a set of magnetic rings. According to an exemplary embodiment as indicated schematically in FIGS. 16 and 16A-16D, the magnet ring may be configured to clip onto/into the ratchet ring; the magnet ring may comprise a clip ring configured to clip into a slot of the ratchet ring; the magnet ring may be configured to fit on the ratchet ring. According to an exemplary embodiment as indicated schematically in FIGS. 17A-17H, the magnet ring may be configured to fit adjacent to the ratchet ring; the magnet ring may be configured to fit within the hub shell; the magnet ring may be configured to fit within a recess in the hub shell; the magnet ring may be configured to fit within a circular recess in the hub shell. The magnet ring may comprise a continuous ring; the magnet ring may be concentric with the ratchet ring. The magnet ring may be configured to magnetize the ratchet ring; the ratchet ring may be configured to magnetize each pawl of the pawl system.

According to an exemplary embodiment as indicated schematically in FIGS. 17A-17H, the magnet arrangement may comprise a magnet ring 145r within a recess 125g within the hub shell 125; the recess may comprise a groove; the magnet ring 145r may project from the groove 125g adjacent to the ratchet ring 135. The ratchet ring may comprise a magnetizable material; the magnet arrangement may be configured to magnetize the magnetizable material of the ratchet ring; the magnetizable material may comprise a metal. The pawl system may comprise a set of pawls; The set of pawls may comprise a magnetizable material; the set of pawls may comprise a metallic material. The ratchet ring may comprise a magnetizable material; the ratchet ring may comprise a metallic material.

As indicated schematically according to an exemplary embodiment in FIGS. 1, 2A-2B, 3, 4 and 18, the wheel hub assembly coupling the hub shell/wheel to the free hub body/axle through the ratchet mechanism is configured to provide two states: (1) a power-transmission/forward state to facilitate transmission of power from the free hub body/axle in a forward direction for forward motion/rotation of the wheel (e.g. by mechanical engagement/coupling of the free hub body/axle to the hub shell/wheel at the ratchet mechanism) when the wheel is moved forward (e.g. with power supplied from the drive system to the wheel hub such as from an operator through the pedals and/or motor, etc.) and (2) a free-wheel/glide/coast state to facilitate free rotary motion/rotation of the free hub body/axle relative to the wheel other than in the forward direction (e.g. by mechanical disengagement/decoupling of the axle/free hub body from the hub shell/wheel at the ratchet mechanism) when the wheel hub is moved in a reverse direction or with motion stopped relative to the wheel (e.g. during “coasting” or “free-wheeling” or gliding or slowing or stopping, etc.). See FIG. 18.

As shown schematically in FIGS. 4, 5, 11A, 12A, 13A, 14A, when the wheel hub assembly is assembled each pawl 140 of each set/group of pawls is configured under action of a magnet 145 to be engaged with the gear teeth 135t of the ratchet ring 135 and retained in engagement during rotation of the free hub/axle relative to the hub shell in the forward direction (e.g. for power supplied from the drive system to the wheel hub); each pawl 140 of each set of pawls is disengaged from gear teeth 135x of the ratchet ring 135 to during rotation of the free hub body/axle relative to the hub shell in the reverse direction (e.g. decoupled for gliding, free-wheeling, coasting, etc.). See also FIGS. 15, 16, 16A-16D, 17A-17H and 18 (magnet//magnet arrangement may comprise a magnet ring for the ratchet ring).

According to an exemplary embodiment of a bicycle as indicated schematically in FIG. 1, in typical use the operator/rider of the bicycle will transition the rear wheel/wheel hub assembly between the power-transmission state and the free-wheel state (e.g. while applying power such as by pedaling, etc.); in operation of the bicycle, the operator/rider may desire that the wheel hub assembly transition between states responsively and rapidly (e.g. depending upon route, terrain, conditions, preferences, etc.). According to an exemplary embodiment shown schematically in FIGS. 2A-2B, 3, 4 and 18, the wheel hub assembly comprises a ratchet mechanism configured to provide enhanced responsiveness in transition to the power-transmission state (e.g. transition to forward pedaling, shifting, acceleration, etc.) with enhanced efficiency/ease in transition to the free-wheel state (e.g. coasting, backward pedaling, etc.). Enhanced responsiveness in transition (and evenness) may be achieved by providing a ratchet mechanism that has enhanced precision in engagement; enhanced precision in engagement may be provided a reduction in the number of degrees of rotation of the free hub body in free travel in the forward direction before the completed transition from the free-wheel state to the power-transmission state; the number of degrees of rotation of the free hub body/axle in free travel (in the forward state) before the completed transition to the power-transmission state may be determined by the number of effective gear teeth in the ratchet ring arrangement (e.g. the number of gear teeth configured to be engaged by a pawl) in a cycle of rotation.

As indicated schematically in FIGS. 2B, 3, 4, 5, 6, 8, 9, 10, 11A-11C, 12A-12C, 13A-13C and 14A-14C, the number of effective gear teeth engaged in the ratchet ring arrangement may also be determined by the number and configuration of ratchet ring (e.g. offset and/or alignment for ratchet ring, etc.); providing multiple ratchet rings in an offset arrangement in the ratchet mechanism (with a corresponding group/set of pawls) will increase the number of effect gear teeth engaged in a cycle of rotation. See also FIGS. 15, 16 and 17A. As indicated schematically in FIGS. 4 and 18, in operation of the ratchet mechanism the free hub body/axle is configured to rotate relative to the hub shell/wheel to produce a series of engagement states (e.g. providing for power-transmission state through the wheel hub assembly) and a series of disengagement states (e.g. providing the free-wheel state at the wheel hub assembly); with the ratchet mechanism in the engagement state (e.g. during power-transmission/drive in the forward direction) the free hub body/axle and hub shell/wheel are driven/rotate together; with the ratchet mechanism in the disengagement state (e.g. during glide/free-wheeling) the free hub body/axle and hub shell/wheel may rotate independently (e.g. wheel may rotate forward while axle rotates in opposite direction remains stationary, wheel may be stationary while axle rotates in backward direction, etc.) until re-engaged at the ratchet mechanism (e.g. by driven forward rotation of free wheel hub/axle to engage hub shell/wheel); the configuration may provide for more even load distribution in the ratchet ring arrangement (e.g. reduced concentration of loading/stress on gear teeth/pawls at the ratchet mechanism) and for greater likelihood of enhanced durability of the wheel hub assembly in operation; in the power-transmission state, load from power input to the wheel hub is carried by the ratchet ring arrangement (e.g. with engaged sets of pawls for the ratchet ring arrangement); the configuration provides for a more rapid/responsive engagement during the transition from the free-wheel state to the power-transmission state.

As indicated schematically, the ratchet ring arrangement of the ratchet mechanism may comprise a variety of engagement/gear configurations (e.g. number of gear teeth, shape of gear teeth, etc.) and/or a variety of pawl/pawl set (e.g. number of pawls, number of sets of pawls, shape of pawls, etc.) configurations and/or with a variety of ratchet ring configurations (e.g. number of ratchet rings, shape of lobes/engagement with hub shell, number of magnets, shape/type of magnets, etc.). See generally FIGS. 2B, 3, 4, 5, 8, 9, 10, 11A-11C, 12A-12C, 13A-13C, 14A-14C, 15, 16 and 16A-16D. For example, a configuration may be provided with six magnets (see FIGS. 4 and 5) or with fewer magnets (see FIG. 15). A configuration with fewer gear teeth may allow for larger gears and greater durability/strength; a configuration with multiple pawls/pawl sets may allow for wider load distribution within the ratchet mechanism; a configuration with multiple offset ratchet rings may allow for improved responsiveness (e.g. more rapid transition to the power-transmission state within fewer degrees of rotation); a configuration with multiple aligned ratchet rings may allow for greater durability/strength and wider load distribution within the ratchet mechanism. As indicated generally, according to an exemplary embodiment the ratchet mechanism of the wheel hub assembly may be configured for performance in any of variety of wide applications, including road biking, mountain biking, electronic bikes (e.g. with motor-driven drive system), etc. See generally FIGS. 1, 2A-2B, 3, 4, 5, 15, 16 and 18.

According to an exemplary embodiment of a bicycle as indicated schematically in FIG. 1, a hub assembly for a wheel may comprise a hub shell coupled to the wheel and a hub body configured for an axle and a ratchet mechanism comprising a ratchet ring and a pawl system and a magnet arrangement configured to provide for magnetically coupling for the ratchet mechanism of the hub body to the hub shell. The magnet arrangement may be configured to magnetically couple the pawl system to the ratchet ring. The ratchet mechanism may be configured to be retained in the hub shell. The pawl system may be configured to couple the ratchet ring to the hub body in an engaged state. The magnet arrangement may comprise a set of magnets; the set of magnets may comprise a set of disc magnets. The magnet arrangement may comprise a magnet ring; the magnet ring may comprise a set of magnetic rings. The magnet ring may be configured to clip onto the ratchet ring; the magnet ring may comprise a clip ring configured to clip into a slot of the ratchet ring. The magnet ring may be configured to fit on the ratchet ring. The magnet ring may be configured to fit adjacent to the ratchet ring. The magnet ring may be configured to fit within the hub shell. The magnet ring may be configured to fit within a recess in the hub shell. The magnet ring may be configured to fit within a circular recess in the hub shell. The magnet ring may comprise a continuous ring. The magnet ring may be concentric with the ratchet ring. The magnet ring may be configured to magnetize the ratchet ring. The magnet ring may be configured to magnetize the ratchet ring; The ratchet ring may be configured to magnetize each pawl of the pawl system. The magnet arrangement may comprise a magnet ring within a recess within the hub shell. The recess may comprise a groove. The magnet ring projects from the groove adjacent to the ratchet ring. The magnet arrangement may comprise a set of magnets within a set of pockets within the hub shell; the set of pockets may comprise a set of seats within the hub shell. The ratchet ring may comprise a magnetizable material; The magnet arrangement may be configured to magnetize the magnetizable material of the ratchet ring; the magnetizable material may comprise a metal. The pawl system may comprise a set of pawls; The set of pawls may comprise a magnetizable material; the set of pawls may comprise a metallic material. The ratchet ring may comprise a magnetizable material; the ratchet ring may comprise a metallic material.

According to an exemplary embodiment, the ratchet mechanism may comprise a configuration as desired to provide a configuration to provide enhanced strength durability, wider/more even load distribution, enhanced responsiveness in transition to the power-transmission state, etc. According to an exemplary embodiment, the ratchet mechanism may comprise a configuration as desired to provide a configuration to provide enhanced strength durability, wider load distribution, enhanced responsiveness in transition to the power-transmission state, etc.

According to an exemplary embodiment, the inner perimeter of the hub shell can be configured to seat/secure a ratchet arrangement with a ratchet ring (or set of ratchet rings) in a variety of arrangements including with aligned or offset (e.g. with gear teeth in alignment or offset) and/or to accommodate a variety of different types/forms of ratchet rings.

As shown schematically according to an exemplary embodiment in FIGS. 2A-2B, 3, 4, 5, 15, 16 and 17A, the wheel hub assembly may be provided in a compact form to allow configuration in a variety of arrangements which can accommodate or provide a variety of different ratchet mechanism configurations (e.g. ratchet ring/pawl combinations with alignment/offset of ratchet rings, etc. providing variations in the number of effective gear teeth to be engaged, degree of rotation before engagement, etc.).

### Exemplary Embodiments—A

According to an exemplary embodiment shown schematically in FIGS. 2A-2B, 3, 4, 5, 6, 7, 8, 9, 10, 11A-11C, 12A-12C, 13A-13C, 14A-14C, 15, 16, 16A-16D and 17A-17H, a hub assembly RH/100 for a wheel RW with an axle may comprise a hub shell 125 configured to be coupled to the wheel and a hub body 155 configured to be coupled to the axle and a ratchet mechanism 180 comprising a ratchet ring 135 configured to couple the hub body to the hub shell; the ratchet mechanism may be configured to provide an engaged state where the hub body may be configured to rotate together with the hub shell; the ratchet mechanism may be configured to provide a disengaged state where the hub body may be configured to rotate independently relative to the hub shell; the ratchet mechanism may be configured for magnetic engagement with the hub body.

According to an exemplary embodiment indicated schematically in FIGS. 1, 4 and 18, the engaged state may comprise a power-transmission state configured for transmission of power to the wheel and the disengaged state may comprise a free-wheel state; the engaged state may comprise a power-transmission state configured for transmission of power to the wheel from the axle and the disengaged state may comprise a free-wheel state.

According to an exemplary embodiment shown schematically in FIGS. 2B, 3, 4, 5, 6, 8, 9, 10, 11A-11C, 12A-12C, 13A-13C and 14A-14C, the ratchet ring 135 of the ratchet mechanism 180 may be configured to engage a set of pawls 140 to provide the engaged state for the ratchet mechanism. The ratchet ring 135 of the ratchet mechanism 180 may be configured to engage a set of pawls 140 with the hub body 155 to provide the engaged state for the ratchet mechanism. The ratchet ring of the ratchet mechanism may be configured for magnetic engagement with the set of pawls. The set of pawls may be pivotally coupled to the hub body. The set of pawls may be configured for magnetic engagement with the ratchet ring of the ratchet mechanism. The set of pawls 140 may be configured for magnetic engagement with the ratchet ring 135 of the ratchet mechanism with a magnet arrangement comprising a set of magnets 145.

According to an exemplary embodiment shown schematically in FIGS. 2B, 3, 4, 5, 7, 8, 9, 10, 11A-11C, 12A-12C, 13A-13C and 14A-14C, the assembly RH/100 may comprise a magnet arrangement 145 configured to provide for magnet engagement; the magnet arrangement may comprise a set of magnets 145. The magnet arrangement may comprise the set of magnets within the hub shell. The magnet arrangement may comprise the set of magnets 145 within a set of seats 125p within the hub shell 125. The magnet arrangement may be configured to provide for magnetization of the ratchet ring 135 of the ratchet mechanism; the ratchet ring of the ratchet mechanism may be configured to magnetically engage a set of pawls to provide the engaged state for the ratchet mechanism. Magnetic engagement with the ratchet ring of the ratchet mechanism may comprise magnetic attraction of a set of pawls to the ratchet ring. Magnetic engagement with the ratchet ring of the ratchet mechanism may comprise magnetic attraction of the set of pawls into a set of teeth of the ratchet ring. Magnetic engagement with the ratchet ring 135 of the ratchet mechanism may comprise magnetic attraction of the set of pawls 140 into the set of teeth 135t of the ratchet ring 135 by magnetization from a magnet arrangement 145. Magnetic engagement with the ratchet ring of the ratchet mechanism may comprise magnetic attraction of the set of pawls into the set of teeth of the ratchet ring by magnetization from a set of magnets of the magnet arrangement. The ratchet ring may be magnetized. The ratchet ring may comprise a magnetizable material or magnetic material. The set of pawls may comprise a metallic material. The ratchet ring may comprise a metallic material. The ratchet ring may comprise a set of teeth. The ratchet mechanism may comprise a set of pawls coupled to the hub body and configured to engage the set of teeth of the ratchet ring. The ratchet ring may comprise a set of teeth configured to engage the set of pawls. In the engaged state of the ratchet mechanism the set of pawls may be in engagement with the set of teeth. In the engaged state of the ratchet mechanism the set of pawls may be magnetically drawn into engagement with the set of teeth.

According to an exemplary embodiment shown schematically in FIGS. 2B, 3, 4, 5, 6, 7, 8, 9, 10, 11A-11C, 12A-12C, 13A-13C, 14A-14C, 15, 16, 16A-16D and 17A-17H, the assembly may comprise a magnet arrangement 145 configured to provide for magnetic engagement of the ratchet mechanism 180 with the hub body 155. The ratchet ring 135 of the ratchet mechanism may be configured to engage a set of pawls 140 to provide the engaged state for the ratchet mechanism. The hub body 155 may be configured to be mechanically coupled to the hub shell 125 through the ratchet mechanism 180. The hub body may be configured to be magnetically coupled for engagement with the hub shell. The hub body may be configured to be magnetically coupled at the ratchet mechanism for engagement with the hub shell. The hub body may be configured to be magnetically coupled at the ratchet ring of the ratchet mechanism for engagement with the hub shell. The ratchet mechanism may be configured to provide the engaged state where the hub body with the axle may be configured to rotate together with the hub shell with the wheel. The ratchet mechanism may be configured to provide the disengaged state where the hub body with the axle may be configured to rotate independently relative to the hub shell with the wheel. The ratchet mechanism may comprise a springless mechanism. The free-wheel state may comprise disengagement of the hub body from the hub shell and disengagement of transmission of power from the axle from the wheel. The ratchet mechanism may comprise a springless configuration; magnetic engagement of the ratchet ring may be configured to provide for reduced hub drag effect. See FIG. 18.

According to an exemplary embodiment shown schematically in FIGS. 2B, 3, 4, 5, 6, 7, 8, 9, 10, 11A-11C, 12A-12C, 13A-13C, 14A-14C, 15 and 16, the hub shell 125 may be coupled to the hub body 155 by magnetic engagement at the ratchet mechanism 180. The assembly may comprise a magnet arrangement 145 configured to magnetically couple the hub body to the hub shell. The magnet arrangement may comprise a set of magnets 145. The hub shell 125 may comprise a set of recesses 125r for the set of magnets 145. The magnet arrangement may be configured to magnetize the ratchet ring. The ratchet ring 135 may comprise a set of lobes 135k. The hub shell may comprise a set of indentations 125r; the set of indentations 125r of the hub shell 125 may be configured to engage the set of lobes 135k of the ratchet ring 135. The ratchet ring 135 may comprise a set of interface surfaces 135n; each magnet 145 in the set of magnets may be configured magnetize the ratchet ring 135 at each interface surface 135n of the ratchet ring 135. The set of interface surfaces 135n of the ratchet ring 135 may be positioned between the set of lobes 135k of the ratchet ring 135. Each of a set of interface surfaces 135n of the ratchet ring may be positioned between each of a set of lobes 135k of the ratchet ring. The ratchet ring may be configured to be installed in the hub body in an aligned condition or an offset condition. Each magnet within the set of magnets may comprise a disc magnet. Each magnet within the set of magnets may comprise a bar magnet.

According to an exemplary embodiment shown schematically in FIGS. 2B, 3, 4, 5, 6, 7, 8, 9, 10, 11A, 12A, 13A, 14A, 15 and 16, a hub assembly RH/100 for a wheel RW may comprise a hub shell 125 coupled to the wheel and a hub body 155 configured for an axle 115 and a ratchet mechanism 180 comprising a ratchet ring 135 and a pawl system 140 and a magnet arrangement 145 configured to provide for magnetically coupling at the ratchet mechanism of the hub body 155 to the hub shell 125; the magnet arrangement may comprise a set of magnets 145 configured to magnetically couple the pawl system 140 to the ratchet ring 135; the ratchet mechanism 180 may be configured to be retained in the hub shell 125; the pawl system 140 may be configured to couple the ratchet ring 135 to the hub body 155 in an engaged state.

According to an exemplary embodiment shown schematically in FIGS. 2B, 3, 4, 5, 6, 15 and 16, the pawl system may comprise a set of pawls 140. The magnet arrangement may comprise magnetization of the ratchet ring. The magnet arrangement may comprise the set of magnets 145 within the hub shell 125. The magnet arrangement may comprise the set of magnets 145 within a set of pockets 125p in the hub shell 125. The hub body 155 may be configured to be engaged for rotation with the hub shell 125 in the engaged state. The hub body may be configured to be disengaged for rotation independent of the hub shell in a disengaged state. The hub body may be configured to be engaged for rotation with the hub shell in the engaged state with the pawl system magnetically attracted into engagement with the ratchet ring. The hub body may be configured to be engaged for rotation with the hub shell in the engaged state; the pawl system may be magnetically drawn into mechanical engagement with the ratchet ring. The ratchet mechanism may be configured to be magnetically drawn into engagement of the hub body and the hub shell. The hub body may be configured to be magnetically coupled at the ratchet ring of the ratchet mechanism for engagement with the hub shell. The hub body may be configured to be engaged for rotation with the hub shell in the engaged state; the pawl system may be magnetically drawn into engagement with the ratchet ring. The hub body may be configured to be magnetically coupled by the pawl system at the ratchet ring of the ratchet mechanism for engagement with the hub shell. The pawl system may comprise a set of pawls configured to couple the ratchet ring to the hub body by engagement with a set of teeth on the ratchet ring. The ratchet ring mechanism may be configured to be retained in the hub shell by a locking ring. The pawl system may comprise a set of pawls pivotally coupled to the hub body. Rotation of the hub shell may comprise (a) rotation with engagement with the hub body when the pawl system may be engaged with the ratchet ring arrangement and (b) rotation without engagement with the hub body when the pawl system may be disengaged from the ratchet ring arrangement. The magnet arrangement may be configured to provide for reduced hub drag effect.

According to an exemplary embodiment shown schematically in FIGS. 2B, 3, 4, 5, 7, 8, 9, 10, 11A-11C, 12A-12C, 13A-13C and 14A-14C, the hub shell 125 may comprise a set of seats 125p; each magnet 145 of the set of magnets of the magnet arrangement may be within a seat 125p of the set of seats within the hub shell 125. The hub shell may comprise a set of seats; each magnet of the set of magnets of the magnet arrangement may be fit within a seat of the set of seats within the hub shell. The set of magnets may comprise six magnets. The ratchet ring 135 may comprise a set of lobes 135k; the hub shell 125 may comprise a set of recesses 125r; the set of lobes 135k of the ratchet ring 135 may be configured to fit within the set of recesses 125r of the hub shell 125. The set of seats of the hub shell may be fit between the set of recesses of the hub shell. The ratchet ring 135 may comprise a set of interface surfaces 135n. A set of interface surfaces 135n may be fit between the set of lobes 135k of the ratchet ring 135. The set of magnets 145 of the magnet arrangement may be configured to magnetize the ratchet ring 135 at the set of interface surfaces 135n of the ratchet ring 135. The ratchet ring arrangement may comprise multiple sets of ratchet rings; each of the multiple sets of ratchet rings may be configured to engage a set of pawls of the pawl system.

According to an exemplary embodiment shown schematically in FIGS. 2B, 3, 4, 5, 8, 9, 10, 11A-11C, 12A-12C, 13A-13C and 14A-14C, the assembly may comprise an interface for coupling the hub body to the hub shell; the interface may comprise the ratchet mechanism. The interface may comprise the profile of pawls of the pawl system for engagement with the ratchet ring system. The interface may comprise a number of sets of pawls for mechanical engagement with gear teeth within the ratchet mechanism. The interface may comprise a number of sets of pawls for engagement with gear teeth within the ratchet mechanism by magnetic attraction. The interface may comprise a number of sets of pawls for engagement with gear teeth within the ratchet mechanism. The interface may comprise mating surfaces of a ratchet ring of the ratchet mechanism with an inner surface of the hub shell. The interface may comprise alignment of the lobes of the ratchet ring with spoke flanges of hub shell. The interface may comprise alignment of magnets between spoke flanges of the hub shell. The interface may comprise centering of magnets between spoke flanges of the hub shell. The lobes may comprise load-carrying lobes configured to fit within recesses under the spoke flanges of the hub shell. The load-carrying lobes may be at the largest section of the hub shell.

According to an exemplary embodiment indicated schematically in FIGS. 2B, 3, 4, 5, 7, 15 and 16, the ratchet ring may be magnetized. The magnet arrangement may be configured to magnetize the ratchet ring. An outside of the ratchet ring may be magnetized and the pawl system may be magnetically attracted into engagement at an inside of the ratchet ring. The pawl system may be pulled into the ratchet ring for engagement by a magnetic force. The pawl system may be pivoted into engagement with the ratchet ring by the magnetic force. The magnet arrangement may comprise a set of magnets at the outside of the ratchet ring to magnetize the ratchet ring to provide magnetic attraction of the set of pawls of the pawl system into the ratchet ring. The set of magnets may be retained in a set of pockets in the hub shell and by the ratchet ring. The set of magnets may be retained in a tight fit within the set of pockets in the hub shell. The assembly may comprise a retaining clip to hold the set of pawls in the hub body.

According to an exemplary embodiment shown schematically in FIGS. 2B, 3, 4, 5, 8, 9, 10, 11A-11C, 12A-12C, 13A-13C, 14A-14C and 15, a hub assembly for a wheel with an axle may comprise a hub shell configured to be coupled to the wheel and a hub body configured to be coupled to the axle and a ratchet mechanism comprising a ratchet ring configured to engage the hub body with the hub shell; the ratchet mechanism may be configured to provide an engaged state where the hub body may be configured to rotate together with the hub shell; the ratchet mechanism may be configured to provide a disengaged state where the hub body may be configured to rotate independently relative to the hub shell; the ratchet mechanism may be configured for magnetic engagement with the hub body. The ratchet mechanism may comprise an interface between the hub shell and the hub body. The interface may comprise the profile of pawls of the pawl system for engagement with the ratchet ring system. The interface may comprise a number of sets of pawls for engagement with gear teeth within the ratchet mechanism. The interface may comprise mating surfaces of a ratchet ring of the ratchet mechanism with an inner surface of the hub shell.

According to an exemplary embodiment shown schematically in FIGS. 2A-2B, 3, 4, 5, 8, 9, 10, 11A-11C, 12A-12C, 13A-13C, 14A-14C and 15, a hub assembly for a wheel may comprise a hub shell coupled to the wheel and a hub body configured for an axle and a ratchet mechanism comprising a ratchet ring and a pawl system and a magnet arrangement configured to provide for magnetically coupling for the ratchet mechanism of the hub body to the hub shell; the magnet arrangement may comprise a set of magnets configured to magnetically couple the pawl system to the ratchet ring; the ratchet mechanism may be configured to be retained in the hub shell; the pawl system may be configured to couple the ratchet ring to the hub body in an engaged state. The hub body may be configured to be engaged for rotation with the hub shell in the engaged state.

The assembly may comprise a hub shell configured to be coupled to the wheel and a hub body configured to be coupled to the axle and a ratchet mechanism comprising a ratchet ring configured to couple the hub body to the hub shell; the ratchet mechanism may be configured to provide an engaged state where the hub body may rotate together with the hub shell; the ratchet mechanism may be configured to provide a disengaged state where the hub body may rotate independently relative to the hub shell. The ratchet mechanism may be configured for magnetic engagement with the hub body. The ratchet ring of the ratchet mechanism may be configured to engage a set of pawls with the hub body to provide the engaged state for the ratchet mechanism; the set of pawls may be pivotally coupled to the hub body. The set of pawls may be configured for magnetic engagement with the ratchet ring of the ratchet mechanism. The assembly may comprise a magnet arrangement configured to provide for magnet engagement. The magnet arrangement may comprise a set of magnets. The magnet arrangement may comprise the set of magnets within a set of seats within the hub shell. The magnet arrangement may be configured to provide for magnetization of the ratchet ring of the ratchet mechanism; the ratchet ring of the ratchet mechanism may be configured to magnetically engage a set of pawls to provide the engaged state for the ratchet mechanism. Magnetic engagement with the ratchet ring of the ratchet mechanism may comprise magnetic attraction of the set of pawls into a set of teeth of the ratchet ring. The assembly may comprise an interface for coupling the hub body to the hub shell; the interface may comprise the ratchet mechanism. The interface may comprise the profile of pawls of the pawl system; the interface may comprise a number of sets of pawls for engagement with gear teeth within the ratchet mechanism by magnetic attraction; the interface may comprise mating surfaces of a ratchet ring of the ratchet mechanism with an inner surface of the hub shell; the interface may comprise alignment of magnets between spoke flanges of the hub shell. The ratchet ring may comprise a set of interface surfaces; each magnet in the set of magnets may be configured magnetize the ratchet ring at each interface surface of the ratchet ring. The set of interface surfaces of the ratchet ring may be positioned between the set of lobes of the ratchet ring. Each of a set of interface surfaces of the ratchet ring may be positioned between each of a set of lobes of the ratchet ring.

### Exemplary Embodiments—B

According to an exemplary embodiment as indicated schematically in FIGS. 2A-2B, 3, 4, 5, 6, 7, 8, 9, 10, 11A-11C, 12A-12C, 13A-13C, 14A-14C, 15, 16, 16A-16D and 17A-17H, an improved wheel hub assembly may comprise a hub shell for a wheel and coupled to a hub body with an axle by a ratchet mechanism and configured to provide a power-transmission/engaged state where the hub body/axle and the hub shell/wheel rotate together and a free-wheel/disengaged state where the hub body/axle may rotate independently relative to hub shell/wheel. See also FIGS. 1 and 18.

According to an exemplary embodiment as shown schematically in FIGS. 2B, 3, 4, 5, 8, 9, 10, 11A-11C, 12A-12C, 13A-13C, 14A-14C and 15, a hub assembly for a wheel with an axle may comprise a hub shell configured to be coupled to the wheel and a hub body configured to be coupled to the axle and a ratchet mechanism comprising a ratchet ring configured to couple the hub body to the hub shell; the ratchet mechanism may be configured to provide an engaged state where the hub body is configured to rotate together with the hub shell; the ratchet mechanism may be configured to provide a disengaged state where the hub body is configured to rotate independently relative to the hub shell; the ratchet mechanism is configured for magnetic engagement with the hub body. See FIG. 18.

The engaged state may comprise a power-transmission state configured for transmission of power to the wheel and the disengaged state may comprise a free-wheel state. The engaged state may comprise a power-transmission state configured for transmission of power to the wheel from the hub body to the hub shell and the disengaged state may comprise a free-wheel state. The ratchet ring of the ratchet mechanism may be configured to engage a set of pawls to provide the engaged state for the ratchet mechanism. The ratchet ring of the ratchet mechanism may be configured to engage a set of pawls with the hub body to provide the engaged state for the ratchet mechanism. The ratchet ring of the ratchet mechanism may be configured for magnetic engagement with the set of pawls. The set of pawls may be pivotally coupled to the hub body. The set of pawls is configured for magnetic engagement with the ratchet ring of the ratchet mechanism.

The assembly may comprise a magnet arrangement configured to provide for magnet engagement. The magnet arrangement may comprise a set of magnets. The magnet arrangement may comprise the set of magnets within the hub shell. The magnet arrangement may comprise the set of magnets within a set of seats within the hub shell. The magnet arrangement may be configured to provide for magnetization of the ratchet ring of the ratchet mechanism; the ratchet ring of the ratchet mechanism may be configured to magnetically engage a set of pawls to provide the engaged state for the ratchet mechanism.

Magnetic engagement with the ratchet ring of the ratchet mechanism may comprise magnetic attraction of a set of pawls to the ratchet ring. Magnetic engagement with the ratchet ring of the ratchet mechanism may comprise magnetic attraction of the set of pawls into a set of teeth of the ratchet ring. Magnetic engagement with the ratchet ring of the ratchet mechanism may comprise magnetic attraction of the set of pawls into the set of teeth of the ratchet ring by magnetization from a magnet arrangement. Magnetic engagement with the ratchet ring of the ratchet mechanism may comprise magnetic attraction of the set of pawls into the set of teeth of the ratchet ring by magnetization from a set of magnets of the magnet arrangement.

The ratchet ring may be magnetized. The ratchet ring may comprise a magnetizable material. The set of pawls may comprise a metallic material. The ratchet ring may comprise a metallic material. The ratchet ring may comprise a set of teeth. The ratchet mechanism may comprise a set of pawls coupled to the hub body and configured to engage the set of teeth of the ratchet ring. The ratchet ring may comprise a set of teeth configured to engage the set of pawls. In the engaged state of the ratchet mechanism the set of pawls is in engagement with the set of teeth. In the engaged state of the ratchet mechanism the set of pawls is magnetically drawn into engagement with the set of teeth.

The assembly may comprise a magnet arrangement configured to provide for magnetic engagement of the ratchet mechanism with the hub body. The ratchet ring of the ratchet mechanism may be configured to engage a set of pawls to provide the engaged state for the ratchet mechanism. The hub body may be configured to be mechanically coupled to the hub shell through the ratchet mechanism. The hub body may be configured to be magnetically coupled for engagement with the hub shell. The hub body may be configured to be magnetically coupled at the ratchet mechanism for engagement with the hub shell. The hub body may be configured to be magnetically coupled at the ratchet ring of the ratchet mechanism for engagement with the hub shell. The ratchet mechanism may be configured to provide the engaged state where the hub body with the axle is configured to rotate together with the hub shell with the wheel. The ratchet mechanism may be configured to provide the disengaged state where the hub body with the axle is configured to rotate independently relative to the hub shell with the wheel. The ratchet mechanism may comprise a springless mechanism.

The hub shell may be coupled to the hub body by magnetic engagement at the ratchet mechanism. The assembly may comprise a magnet arrangement configured to magnetically couple the hub body to the hub shell. The magnet arrangement may comprise a set of magnets. The hub shell may comprise a set of recesses for the set of magnets. The magnet arrangement may be configured to magnetize the ratchet ring. Each magnet within the set of magnets may comprise a disc magnet. Each magnet within the set of magnets may comprise a bar magnet.

The ratchet ring may comprise a set of lobes. The hub shell may comprise a set of indentations; the set of indentations of the hub shell may be configured to engage the set of lobes of the ratchet ring. The ratchet ring may comprise a set of interface surfaces; each magnet in the set of magnets may be configured magnetize the ratchet ring at each interface surface of the ratchet ring. The set of interface surfaces of the ratchet ring is positioned between the set of lobes of the ratchet ring. Each of a set of interface surfaces of the ratchet ring may be positioned between each of a set of lobes of the ratchet ring. The ratchet ring may be configured to be installed in the hub body in an aligned condition or an offset condition.

The free-wheel state may comprise disengagement of the hub body from the hub shell and disengagement of transmission of power from the axle from the wheel.

As indicated schematically according to an exemplary embodiment in FIGS. 1, 2A-2B, 3, 4, 5, 15, 16 and 18, the ratchet mechanism may comprise a springless configuration; magnetic engagement of the ratchet ring may be configured to provide for reduced hub drag effect. The hub body may comprise a free hub body.

According to an exemplary embodiment as shown schematically in FIGS. 2B, 3, 4, 5, 6, 7, 8, 9, 10, 11A-11C, 12A-12C, 13A-13C, 14A-14C and 15, a hub assembly may comprise a hub shell coupled to the wheel and a hub body configured for an axle and a ratchet mechanism comprising a ratchet ring and a pawl system and a magnet arrangement configured to provide for magnetically coupling at the ratchet mechanism of the hub body to the hub shell; the magnet arrangement may comprise a set of magnets configured to magnetically couple the pawl system to the ratchet ring; the ratchet mechanism may be configured to be retained in the hub shell; the pawl system may be configured to couple the ratchet ring to the hub body in an engaged state. See also FIGS. 16, 16A-16D and 17A-17H. The pawl system may comprise a set of pawls. The magnet arrangement may comprise magnetization of the ratchet ring. The magnet arrangement may comprise the set of magnets within the hub shell. The magnet arrangement may comprise the set of magnets within a set of pockets in the hub shell. The hub body may be configured to be engaged for rotation with the hub shell in the engaged state. The hub body may be configured to be disengaged for rotation independent of the hub shell in a disengaged state. The hub body may be configured to be engaged for rotation with the hub shell in the engaged state with the pawl system magnetically attracted into engagement with the ratchet ring. The hub body may be configured to be engaged for rotation with the hub shell in the engaged state; the pawl system is magnetically drawn into mechanical engagement with the ratchet ring. The ratchet mechanism may be configured to be magnetically drawn into engagement of the hub body and the hub shell. The hub body may be configured to be magnetically coupled at the ratchet ring of the ratchet mechanism for engagement with the hub shell. The hub body may be configured to be engaged for rotation with the hub shell in the engaged state; the pawl system is magnetically drawn into engagement with the ratchet ring. The hub body may be configured to be magnetically coupled by the pawl system at the ratchet ring of the ratchet mechanism for engagement with the hub shell. The pawl system may comprise a set of pawls configured to couple the ratchet ring to the hub body by engagement with a set of teeth on the ratchet ring. The ratchet ring mechanism may be configured to be retained in the hub shell by a locking ring. The pawl system may comprise a set of pawls pivotally coupled to the hub body. Rotation of the hub shell may comprise (a) rotation with engagement with the hub body when the pawl system is engaged with the ratchet ring and (b) rotation without engagement with the hub body when the pawl system is disengaged from the ratchet ring. The magnet arrangement may be configured to provide for reduced hub drag effect. The hub shell may comprise a set of seats; each magnet of the set of magnets of the magnet arrangement is within a seat of the set of seats within the hub shell. The hub shell may comprise a set of seats; each magnet of the set of magnets of the magnet arrangement is fit within a seat of the set of seats within the hub shell. The set of magnets may comprise six magnets. The ratchet ring may comprise a set of lobes; the hub shell may comprise a set of recesses; the set of lobes of the ratchet ring may be configured to fit within the set of recesses of the hub shell. The set of seats of the hub shell is fit between the set of recesses of the hub shell. The ratchet ring may comprise a set of interface surfaces. A set of interface surfaces may be fit between the set of lobes of the ratchet ring. The set of magnets of the magnet arrangement is configured to magnetize the ratchet ring at the set of interface surfaces of the ratchet ring. The ratchet ring arrangement may comprise multiple sets of ratchet rings; each of the multiple sets of ratchet rings may be configured to engage a set of pawls of the pawl system.

The assembly may comprise an interface for coupling the hub body to the hub shell; the interface may comprise the ratchet mechanism. The interface may comprise the profile of pawls of the pawl system for engagement with the ratchet ring system. The interface may comprise a number of sets of pawls for mechanical engagement with gear teeth within the ratchet mechanism. The interface may comprise a number of sets of pawls for engagement with gear teeth within the ratchet mechanism by magnetic attraction. The interface may comprise a number of sets of pawls for engagement with gear teeth within the ratchet mechanism. The interface may comprise mating surfaces of a ratchet ring of the ratchet mechanism with an inner surface of the hub shell. The interface may comprise alignment of lobes of the ratchet ring with spoke flanges of the hub shell. The interface may comprise alignment of magnets between spoke flanges of the hub shell. The interface may comprise centering of magnets between spoke flanges of the hub shell. The lobes of the ratchet ring comprise load-carrying lobes configured to fit within recesses under the spoke flanges of the hub shell. The load-carrying lobes may be at the largest section of the hub shell. The magnet arrangement may be configured to magnetize the ratchet ring. An outside of the ratchet ring may be magnetized and the pawl system may be magnetically attracted into engagement at an inside of the ratchet ring. The pawl system is pulled into the ratchet ring for engagement by a magnetic force. The pawl system is pivoted into engagement with the ratchet ring by the magnetic force. The magnet arrangement may comprise a set of magnets at the outside of the ratchet ring to magnetize the ratchet ring to provide magnetic attraction of the set of pawls of the pawl system into the ratchet ring. The set of magnets may be retained in a set of pockets in the hub shell and by the ratchet ring. The set of magnets may be retained in a tight fit within the set of pockets in the hub shell.

The assembly may comprise a retaining clip to hold a set of pawls in the hub body.

According to an exemplary embodiment as shown schematically in FIGS. 2B, 3, 4, 5, 6, 7, 8, 9, 10, 11A-11C, 12A-12C, 13A-13C, 14A-14C and 15, a hub assembly for a wheel with an axle may comprise a hub shell configured to be coupled to the wheel and a hub body configured to be coupled to the axle and a ratchet mechanism comprising a ratchet ring configured to engage the hub body with the hub shell; the ratchet mechanism is configured to provide an engaged state where the hub body is configured to rotate together with the hub shell; the ratchet mechanism is configured to provide a disengaged state where the hub body is configured to rotate independently relative to the hub shell; the ratchet mechanism may be configured for magnetic engagement with the hub body. The ratchet mechanism may comprise an interface between the hub shell and the hub body. The interface may comprise the profile of pawls of the pawl system for engagement with the ratchet ring system. The interface may comprise a number of sets of pawls for engagement with gear teeth within the ratchet mechanism. The interface may comprise mating surfaces of a ratchet ring of the ratchet mechanism with an inner surface of the hub shell.

According to an exemplary embodiment as shown schematically in the FIGURES, a hub assembly for a wheel may comprise a hub shell coupled to the wheel and a hub body configured for an axle and a ratchet mechanism comprising a ratchet ring and a pawl system and a magnet arrangement configured to provide for magnetically coupling for the ratchet mechanism of the hub body to the hub shell; the magnet arrangement may comprise a set of magnets configured to magnetically couple the pawl system to the ratchet ring; the ratchet mechanism is configured to be retained in the hub shell; the pawl system is configured to couple the ratchet ring to the hub body in an engaged state. The hub body may be configured to be engaged for rotation with the hub shell in the engaged state.

According to an exemplary embodiment as shown schematically in the FIGURES, a hub assembly for a wheel may comprise a hub shell coupled to the wheel and a hub body configured for an axle and a ratchet mechanism comprising a ratchet ring and a pawl system and a magnet arrangement configured to provide for magnetically coupling for the ratchet mechanism of the hub body to the hub shell; the magnet arrangement may be configured to magnetically couple the pawl system to the ratchet ring; the ratchet mechanism may be configured to be retained in the hub shell; the pawl system may be configured to couple the ratchet ring to the hub body in an engaged state.

The magnet arrangement may comprise a set of magnets. The set of magnets may comprise a set of disc magnets. The magnet arrangement may comprise a magnet ring. The magnet ring may comprise a set of magnetic rings. The magnet ring may be configured to clip onto the ratchet ring. The magnet ring may be configured to clip into the ratchet ring. The magnet ring may be configured to clip into a slot on the ratchet ring. The magnet ring may comprise a clip ring configured to clip onto the ratchet ring. The magnet ring may comprise a magnetic ring configured to fit adjacent to the ratchet ring.

### Exemplary Embodiments—C

According to an exemplary embodiment as indicated schematically in FIGS. 2A-2B, 3, 4, 5, 6, 7, 8, 9, 10, 11A-11C, 12A-12C, 13A-13C, 14A-14C, 15, 16, 16A-16D and 17A-17H, an improved wheel hub assembly may comprise a hub shell for a wheel and coupled to a hub body with an axle by a ratchet mechanism and configured to provide a power-transmission/engaged state where the hub body/axle and the hub shell/wheel rotate together and a free-wheel/disengaged state where the hub body/axle may rotate independently relative to hub shell/wheel; the ratchet mechanism may comprise a set of ratchet rings configured with a set of teeth and a sets/groups of pawls configured to engage/disengage the teeth of a ratchet ring; the ratchet rings may be configured/installed in the hub body in an aligned condition or an offset condition; when the ratchet rings are configured in an offset condition the ratchet mechanism may be configured to facilitate a generally more responsive/efficient transition between the disengaged state and the engaged state for the hub body/axle and hub shell/wheel.

As indicated schematically according to an exemplary embodiment, the wheel hub assembly may comprise a hub shell for a wheel and coupled to a hub body with an axle by a ratchet mechanism and configured to provide an engaged state where the hub body/axle and the hub shell/wheel rotate together and a disengaged state where the hub body/axle may rotate independently relative to hub shell/wheel; the ratchet mechanism may comprise a set of ratchet rings configured with a set of teeth and a sets/groups of pawls configured to engage/disengage the teeth of a ratchet ring; the ratchet rings may be configured/installed in the hub body in an aligned condition or an offset condition; when the ratchet rings are configured in an offset condition the ratchet mechanism may be configured to facilitate a generally more responsive transition between the disengaged state and the engaged state for the hub body/axle and hub shell/wheel. The wheel hub assembly may comprise a hub shell/wheel and a free hub body/axle coupled by a ratchet mechanism comprising at least one ratchet ring with gear teeth configured to engage a corresponding set/group of pawls so that the wheel and hub body/axle may engage in a power-transmission state such as for forward driven movement; the ratchet mechanism with ratchet rings/pawls may disengage in a free-wheel state. The ratchet mechanism may comprise a ratchet ring arrangement with multiple sets of ratchet rings; with each ratchet ring in offset the number of effective gear teeth per cycle of rotation of the ratchet ring arrangement is greater than the number of gear teeth on each separate ratchet ring; the number of effective gear teeth able to be engaged (e.g. by pawls having a shape/profile to engage from one direction and disengage from one direction with gear teeth during rotation) provides variation of performance characteristics for the wheel hub assembly. For example, a configuration with fewer effective gear teeth may allow for larger gears and greater durability/strength; a configuration with multiple pawls/pawl sets may allow for wider load distribution within the ratchet mechanism; a configuration with multiple offset ratchet rings may allow for improved responsiveness (e.g. more rapid transition to the power-transmission state within fewer degrees of rotation); a configuration with multiple aligned ratchet rings may allow for greater durability/strength and wider load distribution within the ratchet mechanism.

As indicated schematically according to an exemplary embodiment, the pawl system/pawl arrangement may comprise adjacent sets of pawls configured in an aligned condition for engagement with the ratchet ring arrangement; the ratchet mechanism/ratchet ring arrangement may comprise adjacent sets of ratchet rings configured in an aligned condition for engagement with the pawl system. As indicated schematically according to an exemplary embodiment, the pawl system/pawl arrangement may comprise a profile and the ratchet mechanism/ratchet ring arrangement may comprise a profile to provide an interface for the hub shell and hub body; the profile of the pawl system may be configured to mate with the profile of the ratchet ring arrangement to that the profile of the pawls fits with the profile of gear teeth of the ratchet ring arrangement.

According to an exemplary embodiment, the ratchet mechanism of the wheel hub assembly may be configured for performance in any of a wide variety of applications, including road biking, mountain biking, electronic bikes (e.g. with motor-driven drive system). The wheel hub assembly is provided in a compact form/design to allow configuration in a variety of arrangements which can accommodated a variety of different ratchet mechanism configurations (e.g. ratchet ring/pawl combinations).

A wheel hub assembly for a bicycle may comprise a hub shell for a wheel and coupled to a hub body with an axle by a ratchet mechanism and configured to provide an engaged state where the hub body/axle and the hub shell/wheel rotate together and a disengaged state where the hub body/axle may rotate independently relative to hub shell/wheel; the ratchet mechanism may comprise a set of ratchet rings configured with a set of teeth and sets/groups of pawls configured to engage/disengage the teeth of a ratchet ring; ratchet rings may be configured/installed in the hub body in an aligned condition or an offset condition; when ratchet rings are configured in an offset condition the ratchet mechanism may be configured to facilitate a generally more responsive transition between the disengaged state and the engaged state for the hub body/axle and hub shell/wheel. The wheel hub assembly may comprise a hub shell/wheel and a free hub body/axle coupled by a ratchet mechanism comprising at least one ratchet ring with gear teeth configured to engage a corresponding set/group of pawls so that the wheel and hub body/axle may engage in a power-transmission state such as for forward driven movement; the ratchet mechanism with ratchet rings/pawls may disengage in a free-wheel state. The ratchet mechanism may comprise a ratchet ring arrangement with multiple sets of ratchet rings; with each ratchet ring in offset the number of effective gear teeth per cycle of rotation of the ratchet ring arrangement is greater than the number of gear teeth on each separate ratchet ring; the number of effective gear teeth able to be engaged (e.g. by pawls having a shape/profile to engage from one direction and disengage from one direction with gear teeth during rotation) provides variation of performance characteristics for the wheel hub assembly. A configuration with fewer effective gear teeth may allow for larger gears and greater durability/strength; a configuration with multiple pawls/pawl sets may allow for wider load distribution within the ratchet mechanism; a configuration with multiple offset ratchet rings may allow for improved responsiveness (e.g. within fewer degrees of rotation); a configuration with multiple aligned ratchet rings may allow for greater durability/strength and wider load distribution within the ratchet mechanism. The ratchet mechanism of the wheel hub assembly may be configured for a wide variety of applications, including road biking, mountain biking, electronic bikes. The wheel hub assembly is provided in a compact form/design to allow configuration in a variety of arrangements which can accommodated a variety of different ratchet mechanism configurations (e.g. ratchet ring/pawl combinations).

### Exemplary Embodiments—D

According to an exemplary embodiment as indicated schematically in the FIGURES, a wheel hub assembly may comprise a hub shell configured to be coupled to the wheel and a hub body configured to be coupled to the axle and a ratchet mechanism comprising a ratchet ring configured to couple the hub body to the hub shell; the ratchet mechanism may be configured to provide an engaged state where the hub body may rotate together with the hub shell; the ratchet mechanism may be configured to provide a disengaged state where the hub body may rotate independently relative to the hub shell. The ratchet mechanism may be configured for magnetic engagement with the hub body. The ratchet ring of the ratchet mechanism may be configured to engage a set of pawls with the hub body to provide the engaged state for the ratchet mechanism; the set of pawls may be pivotally coupled to the hub body. The set of pawls may be configured for magnetic engagement with the ratchet ring of the ratchet mechanism. The assembly may comprise a magnet arrangement configured to provide for magnet engagement. The magnet arrangement may comprise a set of magnets, a set of magnet elements, a magnet ring, a set of magnet rings. The magnet arrangement may comprise the set of magnets within a set of seats within the hub shell. The magnet arrangement may be configured to provide for magnetization of the ratchet ring of the ratchet mechanism; the ratchet ring of the ratchet mechanism may be configured to magnetically engage a set of pawls to provide the engaged state for the ratchet mechanism. Magnetic engagement with the ratchet ring of the ratchet mechanism may comprise magnetic attraction of the set of pawls into a set of teeth of the ratchet ring. The assembly may comprise an interface for coupling the hub body to the hub shell; the interface may comprise the ratchet mechanism. The interface may comprise the profile of pawls of the pawl system; the interface may comprise a number of sets of pawls for engagement with gear teeth within the ratchet mechanism by magnetic attraction; the interface may comprise mating surfaces of a ratchet ring of the ratchet mechanism with an inner surface of the hub shell; the interface may comprise alignment of magnets between spoke flanges of the hub shell. The ratchet ring may comprise a set of interface surfaces; each magnet in the set of magnets may be configured magnetize the ratchet ring at each interface surface of the ratchet ring. The set of interface surfaces of the ratchet ring may be positioned between the set of lobes of the ratchet ring. Each of a set of interface surfaces of the ratchet ring may be positioned between each of a set of lobes of the ratchet ring.

TABLE A
REFERENCE SYMBOL LIST

| Symbol | Element |
|---|---|
| B | bicycle |
| H | handlebar |
| T | steering tube |
| F | fork |
| FR | frame |
| FW | front wheel |
| RW | rear wheel |
| SH | shock absorber |
| P | pedal |
| ST | stem |
| G | grip |
| BR | brake reservoir for brake system |
| D | brake disc |
| SP | seat post |
| S | seat |
| RH/100 | wheel hub assembly |

TABLE B
REFERENCE SYMBOL LIST

| Symbol | Element |
|---|---|
| RH/100 | wheel hub assembly |
| 105 | endcap (non-drive side) |
| 110 | bearing |
| 115 | axle |
| 120 | spacer |
| 125 | hub shell |
| 125k | spoke flanges (hub shell) |
| 125p | seat/pocket (hub shell) |
| 125r | recess (hub shell) |
| 125g | groove/recess (hub shell) |
| 135 | ratchet ring |
| 135k | lobes (ratchet ring) |
| 135t | teeth (ratchet ring) |
| 135n | interface surface (ratchet ring) |
| 135x | slot (magnet ring) |
| 140 | pawl |
| 145 | magnet |
| 145x | magnet ring |
| 145r | magnet ring |
| 150 | retaining clip |
| 155 | hub body (free hub body) |
| 155p | seat/pocket (hub body) |
| 165 | locking ring (ratchet cap) |
| 170 | endcap (drive side) |
| 180 | ratchet mechanism |
| MF | magnetic force |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A hub assembly for a wheel with an axle comprising:
a hub shell configured to be coupled to the wheel;
a hub body configured to be coupled to the axle;
a ratchet mechanism comprising a ratchet ring and a pawl system configured to engage the hub body with the hub shell;
wherein the ratchet mechanism is configured to provide an engaged state where the hub body is configured to rotate together with the hub shell;
wherein the ratchet mechanism is configured to provide a disengaged state where the hub body is configured to rotate independently relative to the hub shell;
wherein the ratchet mechanism is configured to magnetically couple the pawl system with the ratchet ring.

2. The assembly of claim 1 wherein the ratchet mechanism comprises a set of pawls for engagement with gear teeth within the ratchet mechanism.

3. The assembly of claim 1 further comprising a magnet arrangement configured to provide magnetic engagement; wherein the magnet arrangement comprises the set of magnets within the hub shell.

4. The assembly of claim 3 wherein the magnet arrangement is configured to provide for magnetization of the ratchet ring of the ratchet mechanism; wherein the ratchet ring of the ratchet mechanism is configured to magnetically engage a set of pawls to provide the engaged state for the ratchet mechanism.

5. The assembly of claim 3 wherein each magnet within the set of magnets comprises a disc magnet.

6. The assembly of claim 3 wherein the magnet arrangement comprises a set of magnets adjacent to the ratchet ring to magnetize the ratchet ring to provide magnetic attraction of the set of pawls of the pawl system into the ratchet ring.

7. A hub assembly for a wheel comprising an axle comprising:
a hub shell;
a hub body configured for the axle of the wheel;
a ratchet mechanism comprising a ratchet ring and a pawl system;
a magnet arrangement comprising a set of magnets configured to magnetically couple the pawl system to the ratchet ring;
wherein the ratchet mechanism is configured to be retained in the hub shell;
wherein the pawl system is configured to couple the ratchet ring to the hub body in an engaged state.

8. The assembly of claim 7 wherein the hub body is configured to be engaged for rotation with the hub shell in the engaged state and the hub body is configured to be disengaged for rotation independent of the hub shell in a disengaged state.

9. The assembly of claim 7 wherein the pawl system may be configured to be magnetically drawn into engagement with the ratchet ring.

10. The assembly of claim 7 wherein the pawl system comprises a set of pawls configured to couple the ratchet ring to the hub body by engagement with a set of teeth on the ratchet ring.

11. A hub assembly for a wheel comprising an axle comprising:
a hub shell;
a hub body configured for the axle of the wheel;
a ratchet mechanism comprising a ratchet ring and a pawl system;
a magnet arrangement configured to provide for magnetically coupling for the ratchet mechanism of the hub body to the hub shell;
wherein the magnet arrangement is configured to magnetically couple the pawl system to the ratchet ring;
wherein the ratchet mechanism is configured to be retained in the hub shell;
wherein the pawl system is configured to couple the ratchet ring to the hub body in an engaged state.

12. The assembly of claim 11 wherein the magnet arrangement comprises a set of magnets within a set of pockets within the hub shell.

13. The assembly of claim 11 wherein the magnet arrangement comprises a magnet ring.

14. The assembly of claim 13 wherein the magnet ring is configured to clip onto the ratchet ring.

15. The assembly of claim 14 wherein the magnet ring comprises a clip ring configured to clip into a slot of the ratchet ring.

16. The assembly of claim 14 wherein the magnet ring is configured to fit adjacent to the ratchet ring.

17. The assembly of claim 11 wherein the magnet arrangement comprises a magnet ring within a recess within the hub shell; wherein the recess comprises a groove.

18. The assembly of claim 17 wherein the magnet ring may be configured to project from the groove adjacent to the ratchet ring.

19. The assembly of claim 11 wherein the ratchet ring comprises a magnetizable material; wherein the magnet arrangement is configured to magnetize the magnetizable material of the ratchet ring; wherein the pawl system comprises a set of pawls; wherein the set of pawls comprises a magnetizable material.

20. The assembly of claim 11 wherein the hub body is configured to be engaged for rotation with the hub shell in the engaged state and the hub body is configured to be disengaged for rotation independent of the hub shell in a disengaged state.
